(19) United States
(12) Patent Application Publication
(10) Pub. No.: US 2019/0130739 A1
(43) Pub. Date: May 2, 2019

(54) SELF SYNCHRONIZATION OF MOVING VEHICLES

(71) Applicant: V-Synchronize Tech LLC, Olathe, KS (US)

(72) Inventors: Amol Khedkar, Olathe, KS (US); Vijay Kumar, Lenexa, KS (US)

(21) Appl. No.: 16/169,743

(22) Filed: Oct. 24, 2018

Related U.S. Application Data
(60) Provisional application No. 62/579,484, filed on Oct. 31, 2017.

(51) Int. Cl. G08G 1/09

(52) U.S. Cl. CPC G08G 1/093; G08G 1/20

(57) ABSTRACT

A self-synchronization device and system for vehicles is provided that facilitates the synchronization of traffic at one or more intersections within a designated synchronization space. Generally, the self-synchronization device comprises: (a) a GPS component for receiving location information; (b) a first DSRC radio for providing a control channel inside a designated synchronization cell; (c) a second DSRC radio for a service channel inside the designated synchronization cell; and (d) a third DSRC radio for a long-range communication channel between a plurality of designated synchronization cells. The self-synchronization device and system are configured to synchronize traffic conditions between vehicles in a designated synchronization space so that each vehicle may move through an intersection without a traffic signal or any other external traffic regulating agent.

### RELATED APPLICATIONS

This application claims the priority benefit under 35 U.S.C. § 119(e) of U.S. Provisional Patent Application Ser. No. 62/579,484 entitled “SELF SYNCHRONIZATION OF MOVING VEHICLES,” filed Oct. 31, 2017, the entire disclosure of which is incorporated herein by reference.

### BACKGROUND

### 1. Field of the Invention

The present invention is generally related to traffic coordination systems for vehicles. More particularly, the present invention is generally related to self-synchronizing traffic coordination systems for vehicles.

### 2. Description of the Related Art

Vehicle Safety and improvement in traffic flow has been an important topic of research for the past several years. Every big city in the world is suffering from traffic congestion during peak hours. The government tries to improve the public transportation systems so that the number of vehicles on the roads can be reduced without affecting the traffic flow. New freeways and flyovers are built to reduce the traffic load from certain busy routes at intersections. It is a fact that traffic congestion on roads will continue to remain a serious problem because of a number of factors such as social human behavior and technology to name a few. Traffic congestion, especially at road intersections, is a unique problem that will continue to exist on city roads irrespective of increase or decrease of traffic volume. Our solution tries to manage this issue.

Presently, traffic signals generally manage or synchronize the conflict-free movement of vehicles on road intersections. These signals enforce the traffic rules in order to provide conflict-free movement of vehicles. For instance, each side of traffic is allotted a stipulated time slot for crossing a road intersection. Although the existing traffic signal scheme works well in certain situations, it still exhibits a number of issues. These include the effect of changing traffic volume on traffic flow and indecisiveness of human drivers.

In addition, traffic signals at some locations may be controlled using fuzzy logic (e.g., a micro-controller-based system) so that it open or closes an intersection side based on the number of vehicles present on that side. These systems may work fine when an intersection is saturated, but in sparse traffic, it may open the intersection after a vehicle approaches the intersection and stops. This makes almost every vehicle stop at the intersection even though no other vehicle is present.

Accordingly, there is a need for a new traffic management system that can address most, if not all, of the issues currently plaguing conventional traffic management systems.

### SUMMARY

One or more embodiments of the present invention generally relate to a self-synchronization device for vehicles. Generally, the self-synchronization device comprises: (a) a GPS component for receiving location information; (b) a first DSRC radio for providing a control channel inside a designated synchronization cell; (c) a second DSRC radio for a service channel inside the designated synchronization cell; and (d) a third DSRC radio for a long-range communication channel between a plurality of designated synchronization cells.

One or more embodiments of the present invention generally relate to a computer-implemented method for self-synchronization of vehicles. Generally, the method comprises the steps of: (a) obtaining contextual data from a GPS component of a self-synchronization device positioned in a vehicle when the vehicle enters a synchronization space; (b) establishing a cell master vehicle in the synchronization space; (c) registering the vehicle with the cell master vehicle via a first radio of the self-synchronization device if the vehicle is not established as the cell master vehicle; (d) communicating the contextual data to other vehicles present within the synchronization space via a second radio of the self-synchronization device; (e) receiving comparative contextual data from the other vehicles present within the synchronization space via the second radio; (f) transmitting the contextual data and the comparative contextual data to other synchronization spaces via a third radio in the self-synchronization device if the vehicle is established as the cell master vehicle; (g) formulating a traffic schedule based on the contextual data and comparative contextual data; and (h) providing driving instructions to the vehicle based on the traffic schedule.

One or more embodiments of the present invention generally relate to a self-synchronization system for vehicles. Generally, the self-synchronization system comprises: (a) a memory device for storing data; and (b) a processor communicatively coupled to the memory device, wherein the processor may be programmed to: (i) obtain contextual data from a GPS component in a self-synchronization device of a vehicle when the vehicle enters a synchronization space; (ii) establish a cell master vehicle in the synchronization space; (iii) register the vehicle with the cell master vehicle via a first radio of the self-synchronization device if the vehicle is not established as the cell master vehicle; (iv) communicate the contextual data to other vehicles present within the synchronization space via a second radio of the self-synchronization device; (v) receive comparative contextual data from the other vehicles present within the synchronization space via the second radio of the self-synchronization device; (vi) transmit the contextual data and the comparative contextual data to other synchronization spaces via a third radio in the self-synchronization device if the vehicle is established as the cell master vehicle; (vii) formulate a traffic schedule based on the contextual data and the comparative contextual data if the vehicle is established as the cell master vehicle; and (viii) provide driving instructions to the vehicle in the synchronization space based on the traffic schedule.

### BRIEF DESCRIPTION OF THE FIGURES

Embodiments of the present invention are described herein with reference to the following drawing figures, wherein:

FIG. 1 is a schematic depicting the dynamics of moving vehicles through an intersection;

FIG. 2 is a schematic depicting an exemplary synchronizing space and an exemplary synchronized space at an intersection;

FIG. 3 is a schematic depicting an exemplary synchronizing space including multiple intersections;

FIG. 4 depicts an exemplary communication network configuration of the self-synchronization system that involves multiple synchronization cells;

FIGS. 5A-5D depict a flow chart of the self-synchronization method;

FIG. 6 depicts a synchronization scenario for three intersections;

FIG. 7 depicts a chart showing the execution time taken by the scheduling algorithm;

FIG. 8 depicts a chart showing the execution time taken by the scheduling algorithm;

FIG. 9 depicts a chart showing the maximum wait time for even distribution of vehicles at an intersection;

FIG. 10 depicts a chart showing the maximum wait time for even distribution of vehicles at an intersection;

FIG. 11 depicts a chart showing the average weighted tardiness for evenly distributed vehicles at the intersection;

FIG. 12 depicts a chart showing the average weighted tardiness for evenly distributed vehicles at the intersection;

FIG. 13 depicts a chart providing statistics for execution time for uneven distribution of vehicles as well as random distribution of vehicles;

FIG. 14 depicts a chart providing statistics for maximum wait time for uneven distribution of vehicles as well as random distribution of vehicles; and

FIG. 15 depicts a chart providing statistics for average tardiness for uneven distribution of vehicles as well as random distribution of vehicles.

### DETAILED DESCRIPTION

As discussed below in greater detail, the self-synchronization system of the present invention may provide precise instructions to drivers and/or autonomous vehicles on whether to stop or continue traveling at a designated intersection, regardless of the vehicle's traveling direction. Generally, the instructions provided to the drivers and/or the autonomous vehicles are calculated based on incoming traffic from all directions, which is acquired as contextual data from each of the vehicles in the designated synchronization space. The decisions made for every vehicle is passed to all of the relevant vehicles at or near that intersection so that proper instructions can be provided.

A primary benefit of the inventive system is that it doesn't require an outside administrative system in order to work. In other words, all of the vehicles associated with the system and involved with the relevant intersection(s) arrange a traffic schedule by themselves after communicating contextual information with each other. Therefore, the system of the present invention doesn't require any infrastructure support at intersections and, therefore, can save millions of dollars on energy consumption by traffic signals and other infrastructure equipment.

In various embodiments, the present invention is directed to a novel scheduling scheme and system for conflict-free movement of vehicles at road intersections. The self-synchronizing system of the present invention may provide conflict-free movement for vehicles at any intersection and may also provide nonstop movement for the maximum possible number of vehicles at multiple intersections on its route. If it is not possible to provide a nonstop movement to a vehicle, the self-synchronizing system of the present invention works to minimize the waiting time for each of the vehicles at an intersection.

More particularly, the self-synchronizing system of the present invention focuses on scheduling and optimizing vehicle movement at road intersections. Typically, the self-synchronizing system of the present invention may utilize innovative scheduling schemes that require minimal human intervention so as to provide conflict-free traffic movement at intersections. Consequently, this may lead to the self-synchronization of vehicles at these intersections in which conflicting vehicles mutually synchronize their movement using real-time contextual information. In the self-synchronization approach, vehicles that use the shared resources (intersections) communicate with each other and make a decision who will utilize the resource first based on a fair scheduling algorithm.

As discussed below in greater detail, the self-synchronizing system of the present invention may utilize contextual information related to each of the vehicles in the synchronized space. It is this contextual information that must be exchanged among the vehicles in the synchronization space in real-time. The self-synchronization scheme generates a very dynamic, rapidly changing network of vehicles that requires a unique protocol for reliable real time data communication.

Another aspect of the self-synchronizing system of the present invention involves shifting the process that enforces mutual exclusion from traffic lights to conflicting vehicles. In other words, instead of using a traffic light, conflicting vehicles will mutually decide who and how many vehicles will go through the intersection, and who will wait. Thus, in these embodiments, we refer to the process of enforcing mutual exclusion through a vehicle's “state” exchange (handshake) as “self-synchronization.” More specifically, the self-synchronizing system of the present invention is not changing the traffic light logic for achieving mutual exclusion; rather, the system helps eliminate the role of the third party, i.e., the traffic light in enforcing mutual exclusion to achieve a conflict-free flow of vehicles. In order to facilitate this conflict-free flow of vehicles, the self-synchronizing system of the present invention requires that every vehicle collect and exchange contextual information in real-time to achieve self-synchronization.

Generally, existing communication protocols are unable to achieve a timely exchange of contextual information, and a unique communication system and protocol is needed that must satisfy the temporal and spatial requirements. To achieve this exchange of information among vehicles in the vicinity of an intersection, a protocol and system have been developed that guarantees uninterrupted communication and availability of the contextual information to a “relevant” number of vehicles on time and at the right place. The information is captured by the self-synchronizing system in the vehicle, which shares it with other vehicles in the vicinity; thus, enforcing self-synchronization so that every vehicle can cross the intersection without any conflict and without the support of any external agent.

The self-synchronization scheme of the present invention is based on communication between every vehicle present in the synchronization space. The scheme makes sure that the decision made between each conflicting pair of vehicles (a) is acceptable to them, (b) that each party honors and implements the decision, and (c) that each vehicle enters the intersection as agreed in the decision. Since each conflicting vehicle follows the three criteria in a trustworthy manner, the collision situation may be eliminated. The issue of an ad-hoc situation (human discretion) also does not arise because the decision is binding.

As discussed below in greater detail, the self-synchronization system and protocol of the present invention may establish and provide many benefits. For instance, the self-synchronization system of the present invention may provide a protocol for wireless and mobile communication in vehicular environments that enables reliable vehicle to vehicle (V2V) and vehicle to infrastructure (V2I) communication. In addition, the self-synchronization system may: (i) establish a standard message format for transmitting vehicular contextual information in real time; (ii) provide a solution to solve traffic management issues at intersections without the need of outside traffic management authority (i.e., the inventive system may provide a tool to establish communication among vehicles and a real time scheduling algorithm to synchronize their movements at an intersection); (iii) provide a real time scheduling algorithm to enable nonstop movement of vehicles for up to three consecutive intersections; and (iv) provide a solution that makes sure all vehicles entering an intersection from any direction are treated fairly and not burdened with extended wait times.

Typically, every vehicle (manual or autonomous) has to deal with mutual exclusion issues at a road intersection. We observed that autonomous vehicles would not be fully autonomous unless they resolve the issue of mutual exclusion at intersections without the assistance of a third party. Thus, we have investigated this issue and developed an innovative scheme and system that achieves mutual exclusion at intersections simultaneously. This issue has not been addressed in the prior art.

Furthermore, we have developed an application layer protocol which supports long range multi hop communication based on the Wireless Access in Vehicular (WAVE)/Dedicated Spectrum for Short Range Communication (DSRC) standard. In various embodiments, this protocol provides a base for long range transmission of the contextual information that will facilitate resolving complex traffic issues such as collision avoidance on intersections, traffic synchronization, etc. This protocol also ensures on time delivery of contextual information to desired entities.

### The Self-Synchronization Device and System

As discussed below in greater detail, the self-synchronization system is able to achieve the above objectives by incorporating a self-synchronization device into each vehicle associated with the desired synchronization space. In various embodiments, the self-synchronization device that may be placed in each vehicle comprises: (a) a GPS component for receiving location information; (b) a first DSRC radio for providing a control channel inside a designated synchronization cell; (c) a second DSRC radio for a service channel inside the designated synchronization cell; and (d) a third DSRC radio for a long-range communication channel between a plurality of designated synchronization cells.

In various embodiments, the self-synchronization device may comprise a GPS component for providing spatial information on the vehicle. In various embodiments, this spatial information from the GPS component is encompassed by the contextual information transmitted from the self-synchronizing device. A “GPS component” can include any GPS or GNSS system or device used or known in the art. To provide intelligence (e.g., spatial data) to all the vehicles, the GPS component may be enabled with a special algorithm that will analyze the data received from other vehicles in the designated synchronization space and will be responsible for making decisions based thereon. In certain embodiments, the GPS component may issue voice commands to the drivers of the vehicles corresponding to the decisions made based on the shared data. In certain embodiments, the GPS or GNSS receiver may operate within a 1.5-meter accuracy and at a −135 dBm sensitivity.

In various embodiments, the self-synchronization device may operate using a Linux operating system.

In various embodiments, the first radio, the second radio, and/or the third radio can comprise DSRC-based modems and operate at a frequency of 5.82 to 5.925 Ghz. The DSRC channels are described below in greater detail.

In various embodiments, the self-synchronization device may comprise a special GPS device that has a transceiver connected to it. The transceiver is capable of sending and receiving information using DSRC protocol. In certain embodiments, this transceiver may include the first DRSC radio, the second DSRC radio, and/or the third DSRC radio. The GPS device may be installed in each vehicle within the designated synchronization space. To provide some intelligence to all the vehicles, the GPS device is also enabled with a special algorithm which will analyze the data received from other vehicles and will be responsible for making decisions. The GPS issues voice commands corresponding to decisions made.

In various embodiments, the self-synchronization device may comprise an audio and/or visual interface to communicate the traffic schedule and/or instructions from the self-synchronization device to driver. For instance, the self-synchronization device may comprise a touch screen, touch pad, speaker, or any other audio/visual unit known in the art. Alternatively, if the vehicle is a driverless autonomous car, the self-synchronization device may directly convey the traffic schedule or instructions to the vehicle's main computer. Additionally, the self-synchronization device may also comprise an interface, such as a touch pad, which allows the user to input certain contextual information into the device (e.g., intended location of the vehicle).

In various embodiments, the self-synchronization device may comprise one or more interfaces. Such interfaces may include, for example, a RS232 console, a 10/100 ethernet connection, a can 2.0b connection, an audio jack, an SD card slot, an MMcx connector, GPIO pins, and/or a UART connector. The number of interfaces may vary depending on the use of the self-synchronization device and whether the vehicle is manually operated or autonomous.

In certain embodiments, a self-synchronization device may also be placed at an intersection within the designated synchronization space. The devices placed at the intersections may convey data regarding the intersection to the other self-synchronization devices placed within the vehicles. Furthermore, these self-synchronization devices placed at the intersections may be operably connected to the traffic signals (e.g., traffic lights) at the intersections and may control the traffic signals based on the traffic schedule and instructions sent throughout the self-synchronization network.

As mentioned above, the self-synchronizing system of the present invention utilizes an application layer protocol that supports long range multi hop communication based on the WAVE/DSRC standard. In various embodiments, the self-synchronizing device, particularly the radios, may utilize a WAVE/DSRC standard. This protocol provides a base for long range transmission of the contextual information and may facilitate resolving complex traffic issues, such as collision avoidance on intersections and traffic synchronization. This protocol also ensures on time delivery of contextual information to desired entities.

To make road safety a major priority, the US government (FCC) has provided dedicated spectrum for Short Range Communication (DSRC), which is specifically to be used for road safety and other utility application that involves short range V2V or V2I communication. This spectrum has band width of 75 Mhz on band 5.9 Ghz (5.850 Ghz-5.925 Ghz). Other countries have also provided a dedicated spectrum for this purpose. TABLE 1 displays the list of countries and allocated bandwidths for vehicle-oriented communication.

TABLE 1
Country-based bandwidth listing for DSRC/WAVE protocol

| Region | Bandwidth/band |
|---|---|
| North America | 75 MHz 5.850-5.925 GHz |
| Europe | 70 MHz 5.855-5.925 GHz |
| Japan | 80 MHz 5.770-5.850 GHZ |
| ITU ISM Band | 150 MHz 5.725-5.875 GHZ |

The DSRC/Wave Standards were developed for short range communication. Due to the high speed of moving vehicles, the application environment is very dynamic. In various embodiments, the DSRC 802.11p protocol standard is based on basic 802.11 WIFI protocol standards. Typically, DSRC 802.11p amendment provides guidelines for lower layer protocols (MAC and PHY), whereas the WAVE 1609.4 (Multi Channel Operation) standard provides guidelines for the WAVE protocol stack. TABLE 2 below shows the basic WAVE protocol stack.

TABLE 2
WAVE Protocol Stack

| Non Safety Application | Safety Application |
|---|---|
| TCP/UDP | WSMP |
| IP V4/IP V6 | |

LLC
WAVE MAC (Multi Channel Operation)
PHY (OFDM)

Due to latency and packet delivery ratio constraints in safety applications, it is generally required that the packet sizes are as small as possible. Therefore, the IPV4/IPV6 protocols may not be very useful due to large header size (i.e., the normal IPV6/UDP header size is 52 Bytes). Thus, a new protocol was developed to reduce this overhead, which is named the Wave Short Message Protocol (WSMP) in IEEE 1609.3. TABLE 3 displays the packet structure of WSMP, which only requires 11 bytes for the header. The WSMP protocol also allows controlling of lower layer parameters, such as transmission channel, transmission power, bit rate, receiver MAC, etc.

TABLE 3
WAVE Protocol Header

| 1 | 1 | 1 | 1 | 1 | 4 | 2 | Vari- |
|---|---|---|---|---|---|---|---|
| Byte | Byte | Byte | Byte | Byte | Bytes | Bytes | able |
| Version | Security | Trans- | Trans- | Trans- | PSID | Packet | Data |
| | Type | mission | mission | mission | | Length | |
| | | Channel | Data Rate | Power | | | |

As disclosed above in TABLE 3, the “Version” identifies whether the protocol is supported on the received device; the “Security Type” provides encryption information; the “Transmission Channel,” the “Transmission Data Rate,” and the “Transmission Power” control the radio channel; the “PSID” refers to the Provider Service ID, which identifies the communication circle; and the “Packet Length” describes the length of data carried in the WSM Packet.

The MAC layer in the WAVE protocol stack supports three types of communication: V2V (vehicle to vehicle), V2I (Vehicle to Infrastructure), and I2V (Infrastructure to Vehicle). In the IEEE802.11 architecture, two independent entities can communicate with each other only if they are members of the same service set. Conversely, WAVE applications forming a service may not be feasible due to the time required to form a service set (frequency and time synchronization, association, etc.). Therefore, in a WAVE environment, a new mode is introduced, i.e., Outside the Context of BSS (OCB). In OCB mode, two entities can directly communicate with each other if they are within the range of a radio link. However, in this mode there are no security services provided by MAC layer. The security services are moved to higher layers as defined in IEEE1609.2 standards.

The data transmission in the MAC layer may be controlled using an IEEE802.11 CSMA/CA (Carrier Sense Multiple Access Collision Avoidance) mechanism. The 1609.4 Standard may provide an extension to the WAVE MAC layer that allows a multi-Channel Operation. The multi-channel operation generally utilizes the FDMA/TDMA (Frequency Division Multiple Access/Time Division Multiple Access) technique. The resulting 75 Mhz band is divided into 7 FDMA channels as shown below in TABLE 4.

TABLE 4
Frequency Distrubtion DSRC/WAVE Protocol Channels

| Channel | Usage | Frequency |
|---|---|---|
| Guard | Stop Interference | 5.850-5.855 GHZ |
| 172 | SCH (Service Channel) For Critical | 5.855-5.865 GHZ |
| | Life Safety Messages | |
| 174 | SCH (Service Channel) | 5.865-5.875 GHZ |
| 176 | SCH (Service Channel) | 5.875-5.885 GHZ |
| 178 | CCH (Control Channel) | 5.885-5.895 GHZ |
| 180 | SCH (Service Channel) | 5.895-5.905 GHZ |
| 182 | SCH (Service Channel) | 5.905-5.915 GHZ |
| 184 | SCH (Service Channel) for High Power | 5.915-5.925 GHZ |
| | Transmission Public Safety | |

Channels 174 and 175 can be combined into a single 20 MHz channel 175. Similarly, channels 180 and 182 can be combined into channel 181. Each FDMA channel is then divided in slots of 100 ms where 46 ms slots are allotted to each of the CCH transmission and the SCH transmission. A 4 ms interval works as a guard interval before each transmission. This arrangement is done to allow single channel radios to access both CCH and SCH Services. A single channel radio can either transmit or receive data on a 10 MHz channel, but can't perform both simultaneously.

As noted above, the present invention utilizes the WAVE/DSRC standard to facilitate the self-synchronization process described herein.

In various embodiments, the first radio, the second radio, and/or the third radio of the self-synchronization device operate using DSRC channels. For instance, in various embodiments, the first radio may operate on DSRC channel 182, the second radio may operate on DSRC channels 174, 176, 178, or 180, and/or the third radio may operate on DSRC channel 184.

### The Self-Synchronization System

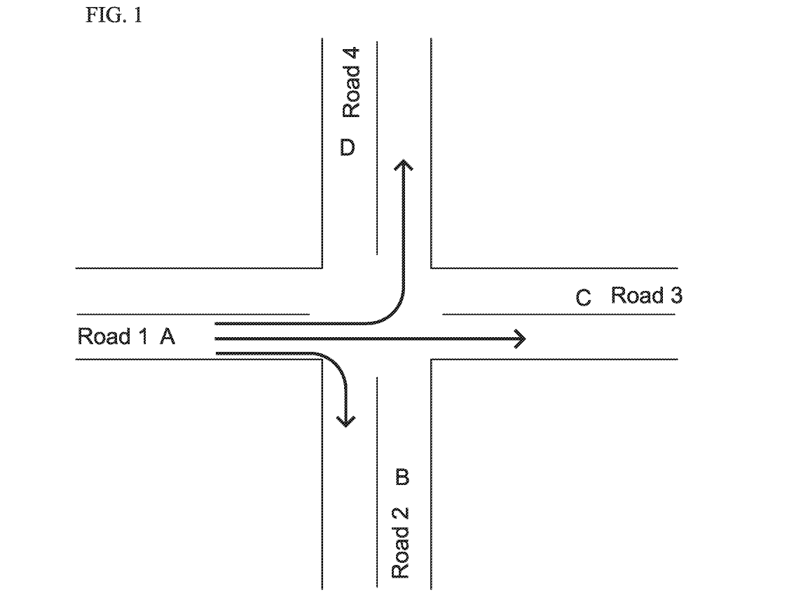

The dynamics of moving vehicles through an intersection are quite complex. For example, FIG. 1 depicts the dynamics of moving vehicles through an intersection with one-lane crossroads marked as Roads 1, 2, 3 and 4. All possible conflict-generating movement directions of Vehicle A from Road 1 to other roads are shown in FIG. 1. When also considering Roads 2, 3, and 4, along with Vehicles B, C, and D, this can result in 12 possible conflict situations. The existence of “turn on red” policies and the priority of emergency vehicles, such as ambulances, police cars, fire vehicles, and so on, further add to the complexity of conflict-free scheduling. Thus, when creating a conflict-free schedule between one must: (i) manage these 12 conflict situations, (ii) generate conflict-free traffic flow with minimum delay at the entry to each intersection, and (iii) repeat this flow as much as possible to subsequent intersections.

In order to achieve conflict-free movement of vehicles, there must be adequate communication and synchronization between the vehicles. To achieve synchronization among vehicles, all the vehicles must be able to transmit and receive information from the other vehicles in the vicinity. Thus, the system of the present invention utilizes the aforementioned self-synchronization device to achieve and facilitate the communication and synchronization between all the vehicles in the designated synchronization space. More particularly, in various embodiments, the self-synchronization devices may be placed into each of the vehicles present within the self-synchronization space. It raises the requirement of a communication protocol to form a communication network among vehicles. Due to the presence of the self-synchronization devices in each of the vehicles, the self-synchronizing system of present invention may exhibit the following properties and characteristics: (i) no centralized controller is necessary for this system since it provides an ad-hoc communication network for data transmission; (ii) a communication protocol may be provided by the system that is dynamic and self-healing, thereby allowing vehicles to readily join or leave the network in the designated synchronized space at any point of time; (iii) accommodate large numbers of vehicles while maintaining reliable communication among the vehicles in real time (due to the use of the three DSRC radios); and (iv) the ability to transmit the contextual information long range for multiple intersection synchronization.

When vehicles receive the contextual information related to all other vehicles in the vicinity, they have to generate a traffic schedule such that they don't cause any conflict while vehicles are accessing the intersection. The schedule of vehicles to access the intersection must be generated in real time because any delay in decision making can cause hazardous situations or can create congestion in intersections. The solution must follow some sort of optimization policies so that the utilization of intersection can be maximized without causing long delays to any of the vehicles trying to access the intersection.

More particularly, the self-synchronization method of the present invention utilizes a mobile communication protocol that provides uninterrupted and timely exchange of contextual information among vehicles for making a decision in the synchronization space. Also, once the decision is calculated, the self-synchronization scheduling algorithm utilizes a communication protocol for transmission of the final decision to the vehicles. Various government agencies have defined DSRC protocol for communication among moving vehicles. This protocol is a short-range communication protocol and has several limitations. In the present invention, the communication range is larger than DSRC protocol can support. Our inventive setup uses a protocol that will transmit data beyond the limit of DSRC protocol.

As noted above, the self-synchronization system of the present invention allows vehicles in a designated synchronization space to communicate with each other and thereby synchronize with one another to form a coordinated traffic schedule in the synchronized space. Consequently, every vehicle can move through the intersection(s) in the synchronized space without the need of traffic signals or any other external regulating agent.

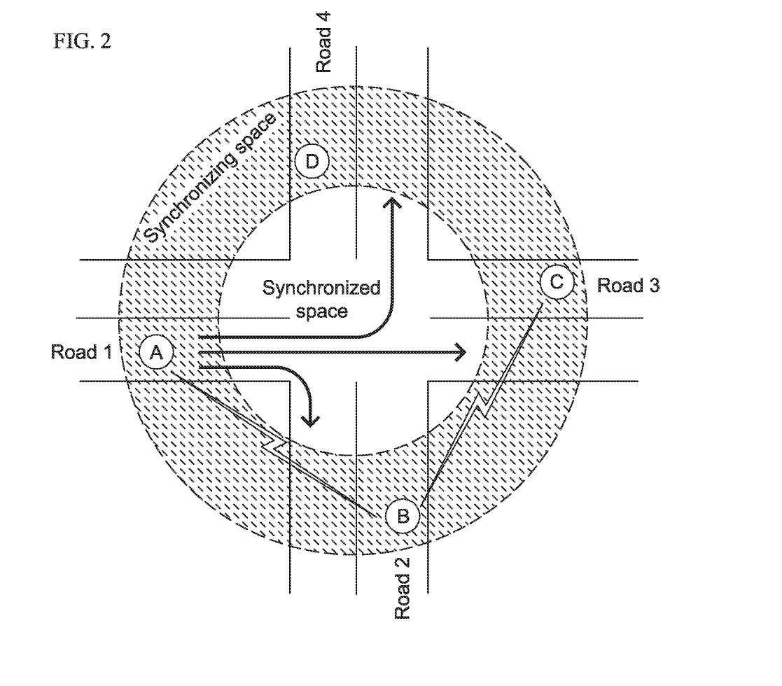

FIG. 2 depicts the setup for self-synchronization at one intersection. A synchronizing space and a synchronized space are depicted in FIG. 2 around an intersection. The outer circle in FIG. 2 represents the synchronizing space. Its size is based on the capacity of the transceiver, speed limit at the intersection, length of conflict-free distance (this may include more than one intersection) and the number of vehicles in the vicinity. The area of a synchronizing space may contain more than one intersection to facilitate nonstop synchronized movement of vehicles across multiple intersections. As soon as vehicles enter the synchronizing space, they start communicating with other vehicles that are already inside the synchronizing space. As used herein, the terms “synchronizing space” and “synchronization space” may be used interchangeably and refer to the same space. Thus, a “designated synchronization space” may also be referred to as the “synchronizing space.”

The smaller circle in FIG. 2 represents the synchronized space. All vehicles must make and receive their decisions from the self-synchronization system before entering the synchronized space. The size of synchronized space is decided based on the speed limit in the synchronization area, number of vehicles present in the vicinity, and the area of the synchronization space.

As depicted in FIG. 2, when the vehicles enter the synchronization space, the self-synchronization devices placed within those vehicles must establish a communication link with all the other self-synchronization devices placed in the vehicles that are already present in the synchronization space of that intersection and then transmit and receive contextual information in real-time.

Typically, vehicles only enter synchronized space only after a mutual decision is made between the vehicles using the self-synchronization system. For example, in FIG. 2 vehicle B is synchronizing with vehicles A and C. This way, each pair of conflicting vehicles from different directions (e.g., A and B) know whether A has to cross the intersection before B or otherwise.

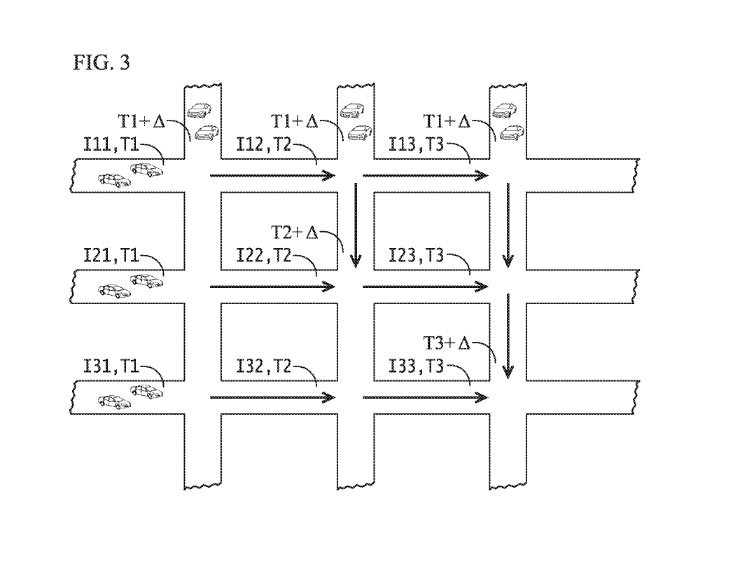

For example, FIG. 3 depicts a scenario involving a synchronization zone comprising a 3×3 grid of intersections, where vehicles are moving from left to right and from top to bottom. The self-synchronization system of the present invention, through the use of the self-synchronization devices placed within the vehicles and the optional self-synchronization devices placed at each intersection, may effectively and efficiently synchronize the traffic schedule at multiple intersections, like those depicted in FIG. 3.

In the exemplary setup depicted in FIG. 3, only one directional flow of traffic is shown. The vehicles at intersection I11, I21 and I31 start moving from left to right at time T₁. If these vehicles move without stopping, they will reach the first intersection at time T₂ and the next intersection at time T₃. To facilitate the non-stop movement for vehicles moving from left to right, the vehicles that are moving from top to bottom must start at T₁+Δ (Δ is a small time interval that is required by the group of vehicles to cross an intersection), so that they will reach the next intersection after the vehicles from the other direction already have crossed the corresponding intersection. This way, vehicles from both directions can cross all the intersections without stopping at any of these intersections.

The example depicted in FIG. 3 illustrates that if one wants to achieve non-stop movement of vehicles through multiple intersections, it requires the synchronization of their movement across multiple intersections on their route. In the example depicted in FIG. 3, the vehicles at intersection I31 must synchronize with the vehicles at I13, and the vehicles at I21 must synchronize with the vehicles at I12. The vehicles starting at I31 do not have to synchronize with the vehicles at I12. Similarly, the vehicles starting at I21 don't have to synchronize with the vehicles at I13 because the timing of these vehicles don't create any conflicting scenarios. Thus, synchronizing traffic at multiple intersections presents a very complex issue.

### The Self-Synchronizing Protocol

One way the self-synchronizing system of the present invention addresses multiple intersections is allowing the self-synchronizing device to transmit contextual data over a long range. This will help the synchronization of vehicle movements in a very large area and multiple intersections. In certain embodiments, this protocol of the self-synchronizing system will make use of a WSW “radio channel control feature” in the application layer to provide high packet delivery ratio in all conditions. The analysis of WAVE/DSRC shows that packet delivery ratio decreases when the number of vehicles increases in one cell. This decrease in ratio is due to the CSMA/CA technique used while acquiring the transmission channel. Therefore, to reduce the number of random data collisions, the self-synchronizing system may utilize an application layer-based solution wherein each vehicle will be provided with a unique virtual ID in a cell. Furthermore, all vehicles in the synchronization space may transmit their data on a specific time slot based on the virtual ID and the number of vehicles in the cell at that time. This approach may reduce data collision in the communication channel because at a given point in time only one vehicle will be trying to transmit a packet. Since data collision will be negligible, the packet delivery ratio will improve.

The protocol utilized by the self-synchronizing system of the present invention may be a bit-oriented protocol and is described in greater detail below. TABLE 5 below shows the packet format for this protocol.

TABLE 5
Self-Synchronization Communication Protocol Packet Format

| | |
|---|---|
| Flag 8 Bits | Version 8 Bits |

Packet length 16 Bit
Sender ID 16 Bit
Location ID 16 Bit
Content fields variable length
(<Type 8 Bit><Length 0-16 Bit><Value length defined by length field>)

As shown above, the “Version” field tells about the version of this protocol. At present this is 1.0 where the last three bits (least significant bits) for decimal digits and 5 bits (most significant bits) are for integer parts. This version is a laboratory version and can be enhanced for outdoor use.

As shown above, the “Packet length” field refers to complete length of the packet in terms of bytes.

As shown above, the “Sender ID” field recognizes the sender, whether it is a static transmitter or a transmission from a car. In either case, the Sender ID uniquely identifies the sender (e.g., the car ID).

As shown above, the “Location ID” field recognizes the cell from where the message is being transmitted. The location is the combination of the cell ID and the intersection ID. This field will be used to identify the Inter-Cell and Intra-Cell communication.

As shown above, the “Content fields” field refers to a variable length field. There can be multiple content fields in a packet. A content field is the combination of three fields. The “Type” can be about 1 byte, wherein 2 MSB tells the size of the length field and 6 LSB tells the type of field. The “Length” can be about 0 to 2 bytes and tells the length of the field value. The “Value” is the value of the content field.

TABLE 6 shows the format of the flag field from this communication protocol. Other fields of this protocol are also depicted in TABLE 6.

TABLE 6
Format of the Flag in the Self Synchronization
Communication Protocol Packet

| Type | Length | Value |
|---|---|---|
| Communication | 1 bit | 0 = Broadcast, 1 = Unicast |
| type | | |
| Packet Type | 4 bit | 0000 = Contextual Information from |
| | | vehicle |
| | | 0001 = Message from static transceiver |
| | | (Infrastructure) |
| | | 0010 = Register Request by vehicle |
| | | 0011 = Drop request by vehicle |
| | | 0100 = Emergency request packet |
| | | 0101 = Registration acceptance |
| | | information |
| | | 0110 = Periodic Message from cell |
| | | DataBridge for resource advertisement |
| | | 0111 = Transfer request for Cell |
| | | DataBridge Responsibility |
| | | 1000 = Acceptance for Cell DataBridge |
| | | Responsibility Can add 7 more packet type |
| Duplicate bit | 1 bit | 0-not a duplicate 1-duplicate packet |
| Unused | 2 bits | Can be used in future |

TABLE 7, below, displays possible values for the content fields.

TABLE 7
Possible Values for Content Fields

| Type | Header Field Name | Description |
|---|---|---|
| 1 | Current Time (Fixed Width 8 Bytes) | Contextual information related to sender. |
| 2 | Longitude (Fixed Width 4 Bytes) | Current Longitude of vehicle |
| 3 | Lattitude (Fixed Width 4 Bytes) | Current Lattitude of vehicle |
| 4 | Speed (Fixed Width 1 Byte) | Current Speed of vehicle |
| 5 | Intersection Lists Variable Width | List of intersection up to 10 that are in order the |
| | with 2 Bytes of length field | vehicle is about to travel. It will be a list of the |
| | | type length value list. |
| 6 | Intersectionid (Fixed Width 8 Bytes) | I.D. of the Intersection |
| 7 | Seconds to Reach (Fixed Width 2 | Time to reach the intersection from the current |
| | Bytes) | time in seconds. |
| 8 | Car List (Variable Width with 2 | List of cars cronologically ordered with respect |
| | Bytes of Length Field) | to their arrival in synchronization space of the |
| | | intersection. |
| 9 | Decision List (Variable Width With | A schedule of vehicles that defines the order in |
| | 2 Bytes of Length Field) | which vehicles are going to access the |
| | | Intersection |
| 10 | Virtual Vehicle ID (Fixed Width 2 Bytes) | Virtual Vehicle ID of a vehicle in a cell |

The above-referenced content fields are defined for a laboratory-based model. The content field has been designed as a highly dynamic field so that it can accommodate any type of future requirement.

It is fairly simple to recognize the message source, i.e., static base stations (static transceiver) or moving vehicles, using the packet type. Similarly, the message content can be easily processed using the content type.

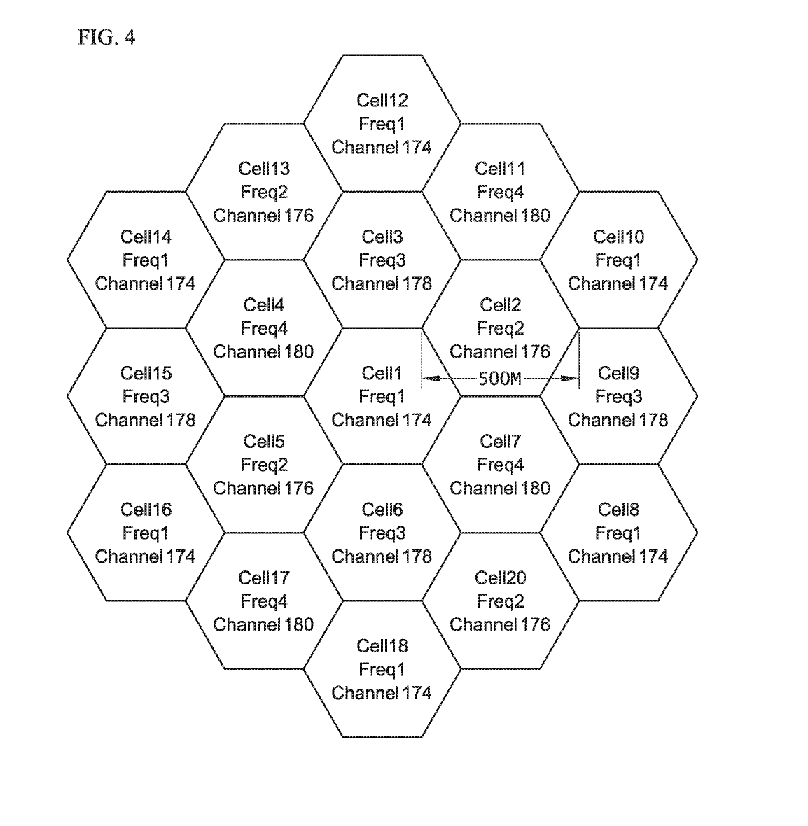

As noted above, the self-synchronization communication protocol of the self-synchronization system may be an application layer protocol, which is developed on top of DSRC/WAVE protocol stack. This protocol should enable short range as well as long range communication channels based on the aforementioned radios present in the self-synchronization devices. In various embodiments, the self-synchronization communication network and the self-synchronization system may be organized into a special cell setup, like the one depicted in FIG. 4.

As shown in FIG. 4, the self-synchronization system and network may be incorporated into and spread over multiple synchronization spaces or cells. As depicted in FIG. 4, each cell in the network may use a different DSRC service channel for data transmission, which helps avoid interference between adjacent cells. Typically, these service channels may comprise DSRC channels 174, 176, 178, or 180. As noted above, the second radio of the self-synchronization device may operate on DSRC channels 174, 176, 178, or 180 and, therefore, this radio of the self-synchronization device may be used to transmit contextual data within the cell. As noted above, the third radio may operate on DSRC channel 184 and be used for inter-cell communications in the layout depicted in FIG. 4. More specifically, channel 184 is assigned for high power transmissions and, therefore, the third radio of the self-synchronization device can be used by the cell masters (as discussed below) to transmit contextual data to other adjacent cells.

In FIG. 4, the radius of each the depicted cells is about 250 meters. Furthermore, the maximum transmission range with the high-power transmission is about 1,000 meters and the transmission range for the normal transmissions (i.e., the intra-cell communications) is about 500 meters.

As mentioned above, the first radio, the second radio, and the third radio of the self-synchronization device in each vehicle are responsible for all inter-cell and intra-cell communications in the layout depicted in FIG. 4. As discussed below in greater detail, the first radio can operate on DSRC channel 182 and communicate with the self-synchronization device of the cell master in the same cell via the first radio in the cell master's device. In addition, the second radio of the self-synchronization device can operate on DSRC channels 174, 176, 178, or 180 and may communicate contextual data between the vehicles in the cell. More specifically, the seconds radios in each of the self-synchronization devices placed within each of the vehicles may be used to transmit contextual data within the cell. Furthermore, the third radio of the self-synchronization devices may be used, usually by the cell master, to transmit contextual data from the cell master's cell to other adjacent cells. As noted above, the third radio may operate using channel 184 to facilitate these long-range communications.

In certain embodiments, the transmission range of the self-synchronization devices in each vehicle is about 1,000 m. In such embodiments, the radius of each synchronization space may be about 500 m. Each synchronization space may be identified with a unique ID (i.e., a Cell ID).

### The Self-Synchronization Method

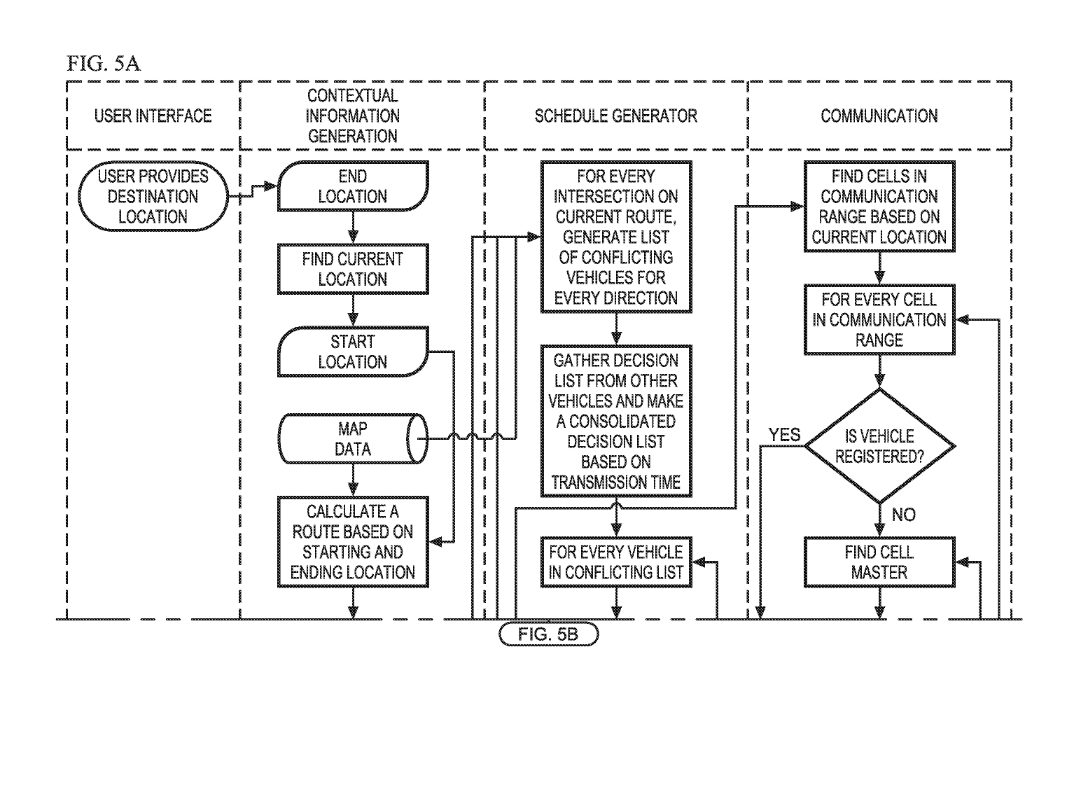

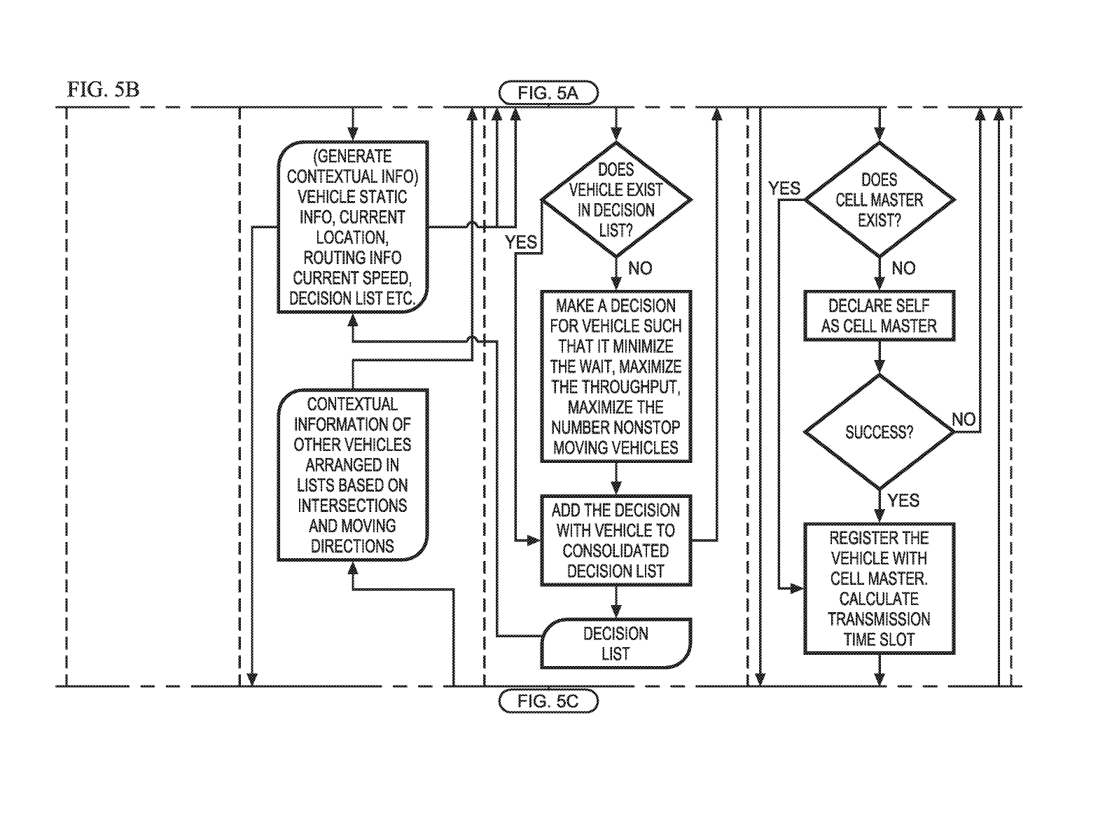

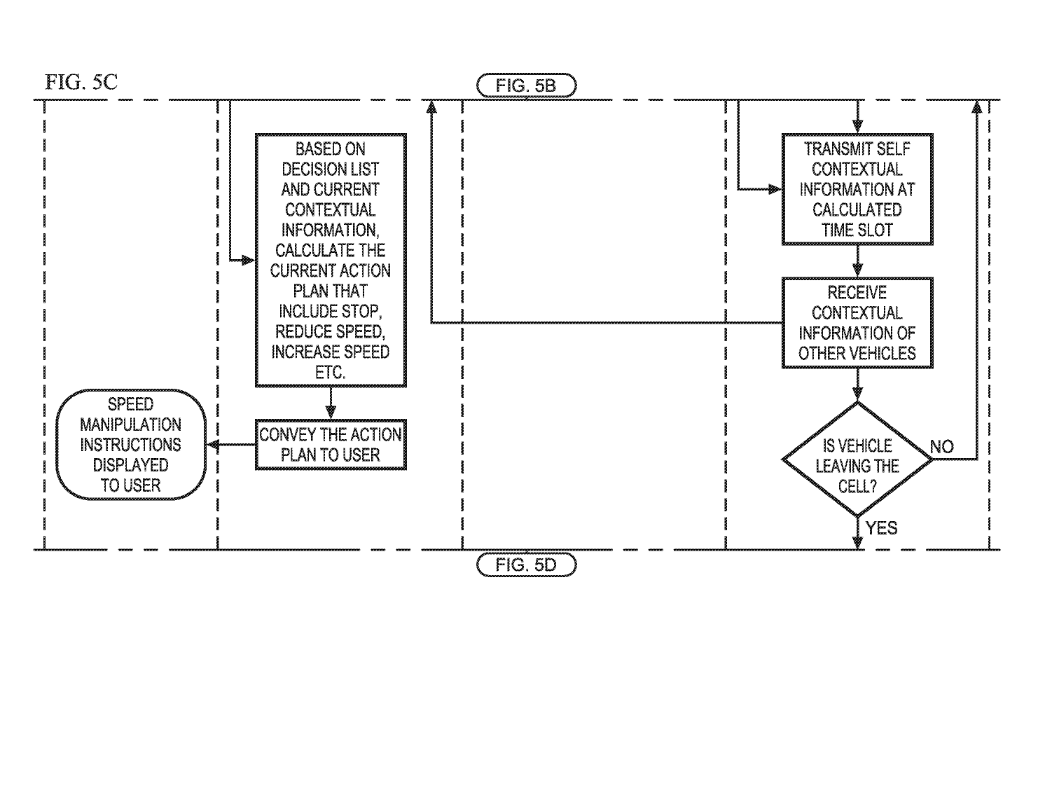

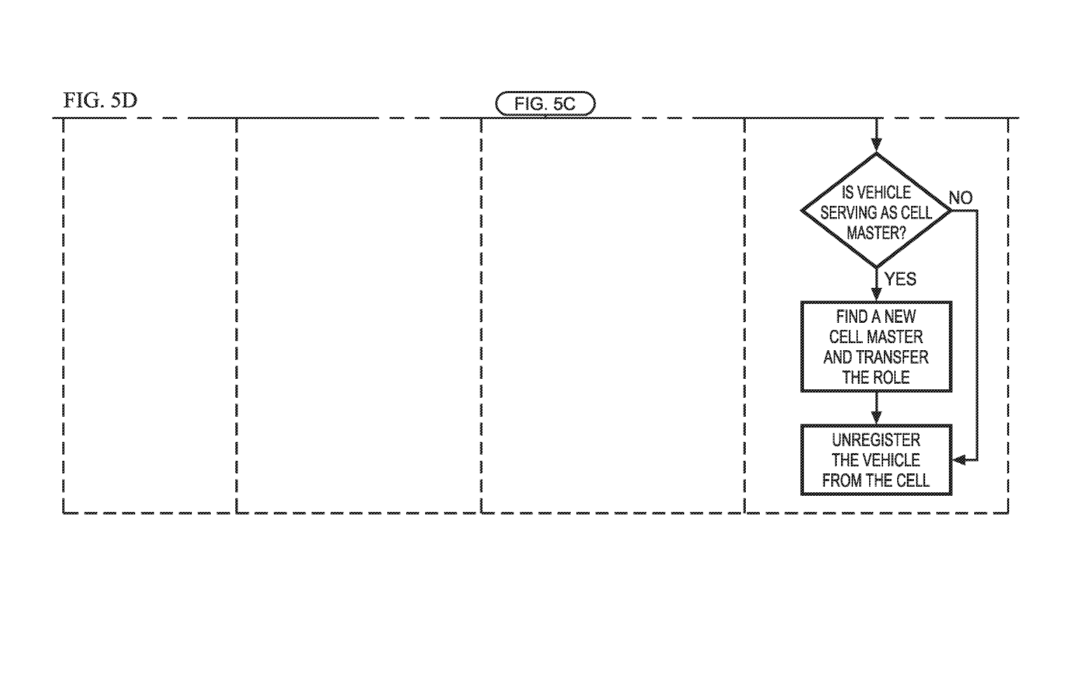

Turning now to the self-synchronization method, the self-synchronization system is configured to synchronize traffic in a designated synchronization space. As used herein, “synchronization space,” “synchronization space,” “designated synchronization cell,” and “cell” may be used interchangeably and define a virtual area on a map that defines boundaries for data transmission for the group of vehicles in that area. FIGS. 5A-5D provide a flow chart of the self-synchronization method of the present invention.

Before turning to the steps of the self-synchronization method, it should be noted that this self-synchronization method and system generally follows these basic principles: (i) every vehicle has to obtain its own contextual information (e.g., using the self-synchronization device, including the GPS component therein) before starting the initial communication with the network and before the vehicle starts moving on the roads within the designated synchronization space and (ii) as soon as the vehicle gathers its own contextual information, it starts listening to the control channel via the first radio of the self-synchronization device for control information from the cell master. In the case of driver-controlled vehicles, the driver may enter some of the contextual information (e.g., desired location of the vehicle) into the self-synchronization device prior to traveling into the synchronization space.

As noted above, the communication network for the self-synchronization system utilizes both intra-cell communication via the first and second radios and inter-cell communication via the third radio.

FIGS. 5A-5D provide a basic flow chart of the self-synchronization method of the present invention. As depicted in FIGS. 5A-5D, the method generally involves the following broad steps:
(1) The user/driver inputs various contextual data into the self-synchronization device placed within the vehicle (e.g., destination location, end location, current location, and start location)—some of this contextual data may be derived from the self-synchronization device itself (e.g., current location and map data from the GPS component).
(2) The self-synchronization device will then calculate a route based on the starting and ending location and thereby generate the contextual information to send out into the synchronization space.
(3) The self-synchronization device will then identify synchronization spaces within communication range based on the current location of the vehicle.
(4) When entering a synchronization space, the self-synchronization device in the vehicle will communicate via the first radio over DSRC channel 182 to determine if there is a cell master within the space. If no, cell master is present, then the vehicle will declare itself cell master within the space. If a cell master is present within the synchronization space, then the vehicle will register itself with the cell over via the first radio of the self-synchronization device. The cell master will then assign the vehicle an ID number and a listing of other registered cars in the space. The self-synchronization device in the vehicle will utilize this list to calculate a transmission time slot within the synchronization space to submit its contextual information to other vehicles in the synchronization space via the second radio (DSRC channels 174, 176, 178, or 180).
(5) The vehicle communicates its contextual information to other vehicles in the synchronization space according to its assigned time slot via the second radio of self-synchronization device within the vehicle. In addition, the vehicle will also receive contextual information of the other vehicles via the second radio of self-synchronization device.
(6) The cell master will send out the listing of vehicles to all vehicles within the synchronization space. The self-synchronization devices in each of the vehicles will use this list to make a consolidated decision list for every vehicle in the space. In addition, a traffic schedule may be formulated using the contextual information shared by all of the vehicles in the self-synchronization space. This traffic schedule attempts to minimize wait times, maximum the throughout through intersections within the synchronization space, and maximum of the number of non-stopping vehicles. This traffic schedule and every vehicle's contextual information will be openly shared to all vehicles in the synchronization space.
(7) The self-synchronization device in the vehicle will then transmit driving instructions based on the traffic schedule to the operator of the vehicle via an audio/visual interface connected to the self-synchronization device. Alternatively, if the vehicle is an autonomous vehicle, the self-synchronization device will convey the driving instructions based on the traffic schedule directly to the central computer of the vehicle. The instructions generally indicate when to adjust the speed of the vehicle and/or where/when to stop the vehicle.
(8) Upon leaving the synchronization space, the vehicle will communicate with the cell master and remove itself from the list. If the cell master leaves the synchronization space, a new cell master is identified within the remaining vehicles in the synchronization space.

To provide more details, the method begins by the user incorporating some initial contextual information (e.g., desired end location of the vehicle) into the self-synchronization device via an interface (e.g., a touch pad). The self-synchronization device may also gather other contextual information (e.g., current location via the GPS component and the desired start location).

Next, the vehicle listens to the control channel for the broadcast from the cell master via the third radio and DSRC channel 182. If no cell master is present within the synchronization space, the vehicle will announce itself as the cell master. To avoid two or more vehicles announcing themselves as cell masters at the same time, this protocol may use the CSMA/CA technique.

The moving vehicles form a dynamic network in each cell. Since there is no external static agent that can handle the responsibility of the server, a “cell master” (leader) must be selected among the existing vehicles in the cell. The cell master is one of the vehicles inside the synchronization space that is responsible for communicating contextual information of all the vehicles the space to the other cell masters in the adjacent synchronization spaces. It should be noted that all communications and instructions from the cell master to the other vehicles in the synchronization space is generally carried out by the first radio of the self-synchronization device. In addition, the cell master may utilize the third radio of the self-synchronization device to transmit the contextual data from its synchronization space to cell masters in adjacent synchronization spaces.

Once the cell master is recognized, each vehicle sends its identification number to the cell master on the control channel via the third radio and DSRC channel 182. The identification number is unique to each vehicle just like a MAC ID. The cell master then registers the vehicles and sends back a unique virtual id, within the cell, to the registered vehicle.

The cell master maintains a list of vehicles that are present in the cell. When the cell master receives a new vehicle ID, it adds the ID to the list while maintaining a chronological order of the vehicle's arrival. Furthermore, the cell master broadcasts the list of vehicles in the cell in its broadcast on the control channel via the first radio on DSRC channel 182. During this communication period, there may be data collisions when multiple vehicles send out communications at the same time. Thus, these steps are repeated until the vehicle receives a list with its own vehicle ID.

Next, the self-synchronization device in each vehicle calculates a time slot based on the number of vehicles in the list and its own location in the list. The time slot calculation uses some assumptions about the amount of data to be communicated by each vehicle. Each vehicle continues to listen to the service channel via the first radio (DSRC channel 182) and keeps its own time slot updated with the cell master based on the time taken by previous transmissions.

The car starts transmission of its contextual information when its own time slot occurs. It is possible that more than one car is trying to transmit at the same time. This situation is taken care by the CSMA/CA protocol. Consequently, this avoids “wait and hold” scenarios in the self-synchronization network. In other words, this prevents the possibility of deadlock in the communication network.

It should be noted that the above steps keep repeating as long as there is at least one vehicle in the synchronization space. In other words, the self-synchronization device in each of the vehicles will repeatedly check in with the cell master over the first radio and continuously submit updated contextual information to the other vehicles over the second radio.

Once a vehicle leaves the synchronization space, the cell master removes the vehicle ID from the list as soon as the vehicle leaves the space. When a cell master is about to leave the cell, it selects a new candidate to be cell master based on how long the new candidate is going to remain in the cell.

Furthermore, only the cell masters in the synchronization space are involved in inter-cell communications with adjacent synchronization spaces. The self-synchronization devices in the cell masters will communicate with these adjacent cells via the third radio (DSRC channel 184). Each cell master will transmit the contextual information about the vehicles in its own space as well as for all the vehicles in the adjacent cells. Generally, communication among cell masters will be handled using CSMA/CA protocol. In most embodiments, there will be at most 19 cells (as depicted in FIG. 4) that are competing for inter-cell transmission at any given point in time.

### The Self-Synchronization Algorithm

The algorithms utilized by the self-synchronizing devices and systems of the present invention are now described in greater detail below. Generally, the self-synchronization scheduling problem can be solved using two approaches. The first involves a static approach which is a simple stop-and-go solution where each vehicle will wait for all other vehicles that are already in the queue before passing the designated intersection. Alternatively, a dynamic approach may be used, which is a complex expert system based upon an algorithm that generates the near optimal schedule for all the vehicles at the intersection based upon the optimization criteria.

Generally, the static approach works only at four-way stop intersections. This approach is useful when priority and processing times for all the vehicles are the same, but with batch dependent setup times this approach is not feasible.

The problem of the self-synchronization at one intersection is a real time problem and must be solved within a very short time frame. For example, at 40 mph, a vehicle travels 17.78 meters per second. This means that the dynamics of the problem change every second. The number of vehicles in the problem area, their position, and their release time will be different in one second. The solution for the problem could be very different when a new vehicle joins the synchronization space. Therefore, the solution must be found within a very short stipulated time slot. We assume that problem dynamics remain constant during this time slot. Genetic algorithms and neighborhood searches require the generation of multiple solutions and their comparison, which could be very time consuming, hence may not be effective in this scenario. This is a very special problem; therefore, a problem specific expert system may be used to generate fast and near optimal solutions. In special cases, the expert system approach may work as well as the static approach and will be capable of handling all sorts of scenarios at an intersection.

It can be very important to represent the candidate solutions in effective ways such that the feasibility of solutions can be tested quickly and easily. The representation of solutions must be simple to understand. For the self-synchronization at one intersection problem, the solution should provide a schedule for the vehicles in the problem domain. Using this schedule, any vehicle in the problem domain must be able to determine when it can access the intersection.

In order to address this scenario, the solution vector generated at base time T₀ may be represented as follow:

SV₁={V₁,V₂ . . . Vₙ}

In this solution vector, vehicles are arranged in the order that they should access the intersection. To calculate the feasibility of this solution, it requires the determination of the completion time Ci for each vehicle. That can be done by coupling the start time Si and processing time pi with each vehicle node. To make the feasibility calculation easy, we should also provide the due date information of each vehicle. In our problem there are direction dependent setup times. Since we include start time, processing time, and due date with each node, it is not required to include setup time in the resulting schedule. We can also add wait time for each vehicle in the resulting schedule to ease the calculation of waitₘₐₓ calculations. After considering all the points noted above, the modified solution vector can be as below:

SV₁={(V₁,s₁,p₁,d₁,w₁),(V₂,s₂,p₂,d₂,w₂) . . . } (Solution 2)

When vehicles are ready to access the intersection from all the conflicting directions, Waitₘₐₓ will be minimum if we change the direction in a round robin way after every passing vehicle. Waitₘₐₓ will be maximum if we allow all the vehicles from one direction to go before changing the direction. The upper bound of Waitₘₐₓ can be calculated as outlined below:

(a) Add the processing time for all the vehicles in each of the directions separately.

(b) Discard the total processing time for the direction with the minimum processing time.

(c) Add the total processing time for the remaining directions.

(d) Add the setup time for all the directions.

The upper-bound calculated for Waitₘₐₓ using the above procedure may not be feasible when the intersection is saturated from at least one direction. That means at least one direction has a very long queue waiting to access the intersection. In this kind of scenario, we must define a threshold value for Waitₘₐₓ. For example, at a 4-way intersection, if we allow each conflicting direction for a maximum of 30 seconds, then the threshold limit for Waitₘₐₓ should be 90+ΣST. The max time for each direction can be defined with intersection properties.

When traffic is very low, the optimization criteria of Waitₘₐₓ may cause the change of directions frequently to get the optimal result, but it is not feasible to change the direction in the low traffic scenario. Instead, all the vehicles from one direction should be allowed to go before changing directions in order to increase the throughput. In the low traffic scenario, Waitₘₐₓ doesn't have any significance. Hence, we must set a Lower Bound for Waitₘₐₓ. The Waitₘₐₓ optimization criteria should be ignored if upper bound of Waitₘₐₓ is less than its Lower Bound. The lower Bound for Waitₘₐₓ should also be defined with intersection properties.

For example, let there be 4 conflicting directions and A, B, C and D be a set of vehicles from each of the conflicting directions. Let V be the set of all the vehicles. Accordingly, the following properties hold:

A∩B=A∩C=A∩D=B∩C=B∩D=C∩D=A∪B∪C∪D=V

If Pi be the permutation set of all possible sequences of n number of vehicles from V and precedence rule of vehicles in A, B, C, and D is ignored then there will be !n possible sequences. In our problem, we need to keep the precedence of vehicles from A, B, C and D. if |A|=w, |B|=x, |C|=y, |D|=z then the total possible permutations in set Pi are:

1n/1w*1x*1y*1z

If S be one of the arbitrary solution sequence from Pi and if total tardiness is optimization criteria which is represented as function f(S) for solution S then:

f(S)={Σ_{i=1 to n}max(cᵢ−dᵢ,0)} (2)

Suppose we find an optimum solution for this problem and S*=[{v₁*}, {v₂*}, {v₃*}, . . . (vₙ*}} is the optimum schedule of vehicles. Then using (2)

f(S*)={Σ_{i=1 to n}max(cᵢ*−dᵢ*,0)}

The above equation can be decomposed for any 1<=k<=n:

f(S*)={Σ_{i=1 to k}max(cᵢ*−dᵢ*,0)}+{Σ_{i=k+1 to n}max(cᵢ*−dᵢ*,0)}+ (2)

f(S*)=f(S₁*)+f(S₂*) (3)

where S₁*={{v₁*}, {v₂*} . . . [symbol] *}} and S₂*={{vₖ₊₁*}, {vₖ₊₂*} . . . [symbol] *}}

Let A₁=S₁*∩A,A₂=S₂*∩A

B₁=S₁*∩B,B₂=S₂*∩B

C₁=S₁*∩C,C₂=S₂*∩C

D₁=S₁*∩D,D₂=S₂*∩D

Then the following Lemma is true:

Lemma 1: If S* is the optimum sequence for vehicles in A, B, C, and D then the subsequence S₁* obtained in (3) is the optimum sequence for vehicles in reduced sets A₁, B₁, C₁, and D₁.

Proof: if S₁* is not the optimum sequence for the vehicles in reduced sets A₁, B₁, C₁, and D₁ then we can find an optimum sequence for this subset. Let this optimum sequence be S₁₁* such that S₁₁*< >S₁* and f(S₁₁*)<f(S₁*).

Now we can construct a new sequence for the vehicles in A, B, C, and D by combining S₁₁* and S₂*. The objective function value of this new sequence will be f(S₁₁*)+f(S₂*) which is less than f(S₁*)+f(S₂*). This contradicts the assumption that S* is the optimum sequence for vehicles in A, B, C, and D. Thus, the converse is true that S₁* is the optimum sequence for the vehicles in the reduced sets A₁, B₁, C₁, and D₁.

Let V₁ be the subset of V and V₂=V−V₁ which is the complement of V₁. Let C_{V1} be the sum of processing time for all the vehicles in V₁.

C_{V1}=Σᵥ_{₁}_{∈V}_{₁}ₚ_{ᵢ} (4)

Suppose a solution sequence S for V is created such that all the vehicles in V₁ are accessing the intersection before all the vehicles in V₂. If S is the optimum solution for V, then according to lemma 1 the vehicle from V₁ must be optimally sequenced irrespective of how vehicles from V₂ are sequenced. Because no vehicle in V₂ will access the intersection before C_{V1}, we can construct the reduced conflicting direction subsets A₁, B₁, C₁, and D₁ as

A₁=V₁∩A,B₁=V₁∩B,C₁=V₁∩C,D₁=V₁∩D.

So the minimum tardiness value for V₁ will be:

$$F ( {V}_{1} ) = f ( {S}_{V 1}^{*} ) = {min}_{{S}_{{V}_{1}} ∈ {P}_{1}} \{ {\sum }_{{v}_{i} ∈ {V}_{1}} max ( {c}_{i} - {d}_{i} , 0 ) \} \qquad ( 5 )$$

Where Pi is permutation set V₁ while maintaining the precedence order of the vehicles in A₁, B₁, C₁, and D₁. If vₖ is the last vehicle to access the intersection from V₁, then its corresponding access time will be C_{V1}. So, (5) can be written as below:

$$F ( {V}_{1} ) = f ( {SV}_{1}^{*} ) = {min}_{{S}_{{V}_{1}} ∈ {P}_{1}} \{ max ( {C}_{V 1} - {d}_{{v}_{k}} , 0 ) + F ( {V}_{1} - \{ {v}_{k} \} ) \} \qquad ( 6 )$$

If V₁ is empty then we define F(Φ)=0 which is the boundary condition. We can generalize (6) for the entire problem as below:

$$\begin{matrix}f ( V ) = f ( {S}^{*} ) = {min}_{S ∈ {P}_{i}} \{ {\sum }_{{v}_{i} ∈ V} max ( ( {c}_{i} - {d}_{i} ) , 0 ) \} \\ = {min}_{S ∈ {P}_{i}} \{ max ( {C}_{V} - {d}_{{v}_{k}} , 0 ) + F ( V - \{ {v}_{k} \} ) \}\end{matrix} \qquad ( 7 )$$

The iterative equations (6) and (7) and the boundary condition F(Φ)=0 allows us to find the minimum value of the optimization function for the whole problem. We can take the bottom up approach and start from only one vehicle in V₁ and using (6) find the minimum value for the first vehicle from each conflicting direction. Then we can move on with two vehicles in V₁ having different combination of vehicles from each conflicting direction. The minimum values we find in prior steps will be stored to be used in later steps so that we can save the additional iterations. Using this method, we can avoid to iterating through all possible permutations. It therefore provides a faster solution for our problem.

Through using this dynamic programming method stated above, we avoid iteration through every possible set of permutations, yet the complexity of this algorithm is still very high which expands quickly with the increase in number of vehicles in V.

As discussed above, the self-synchronization of one intersection problem is a unique scheduling problem where the vehicle's arrival rate at the intersection is random. At some point in time, the arrival rate may be very high and at other times it may be very low. It causes delay if vehicles have to stop at the intersection which is referred to as the batch dependent setup time.

The job families of this problem are both compatible as well as incompatible. If A, B, and C are three families at the intersection, there may be a case where A and B are compatible, A and C are compatible, but B and C are not compatible. At a 4-way intersection, directions like turn right can be grouped together with two different groups of direction. We mark them as minor directions. The directions like turn left and go straight are major directions. While scheduling, we give priority to major directions. It doesn't cause any delay to vehicles moving in minor directions, since they can be batched twice for processing in one scheduling cycle of all directions. Based on the compatibility matrix for a 4-way intersection, there are four conflicting groups of directions.

Due to the setup time that is required while switching the direction for processing vehicles, it is very important to find feasible lot sizes from each direction. In this problem, the total processing time of a lot depends on jobs included in the lot. If all the vehicles have the same processing time, then including all the vehicles from one direction before moving to the others can be a good strategy to optimize the average tardiness. This approach results in high Waitₘₐₓ values. On the other hand, to get optimal Waitₘₐₓ value, changing the direction with every passing vehicle is best. When we bind these two optimization criteria, the best result is when the lot size is half the number of vehicles from one direction (assume vehicles are evenly distributed).

In the real world this is not the case. The processing time for vehicles varies. Also, the vehicles are not distributed across the direction of movement. Considering the real-world scenario, it becomes more important to find a feasible lot size from each direction. Due to the batch dependent setup time, selecting the next family to process does impact the optimization value.

Let A, B, C and D are a set of vehicles from 4 conflicting directions and V is the set of all the vehicles. If Pi is the set of the permutation sequence on V, S be one of the sequences from Pi. Finding the optimal solution from all the possible permutations is very difficult. We propose the following approach to find a feasible solution for this problem: (a) find a direction to process next; (b) find a feasible batch size to process from a selected direction; and (c) mark the batch as scheduled and repeat the steps for the remaining vehicles until all the vehicles are marked scheduled.

If there are K conflicting directions, there are !K possible ways to select the next direction for processing. We propose introducing preferred cycle rules for conflicting directions. For example, in this case the preferred cycle of direction could be A->B->C->D and repeat. Further, selection of the next direction to process will be based on the availability of vehicles from the direction and wait time of the direction. The Solution S can be shown as below:

S={A₁,B₁,C₁,D₁,A₂,B₂,C₂,D₂, . . . Aₙ,Bₙ,Cₙ,Dₙ}

Where Aᵢ⊂A,Bᵢ⊂B,Cᵢ⊂C,Dᵢ⊂D

Aᵢ∩Aⱼ=ϕ∀i≠j and UAᵢ=A

Suppose S* be the optimal sequence of batches as below:

S* [symbol] {A₁*,B₁*,C₁*,D₁*, . . . A [symbol] Bₙ*,Cₙ*,Dₙ*}

Then optimization function for set S* is

$$f ( {S}^{*} ) = {min}_{{S}^{*} ∈ {P}_{1}} \{ {\sum }_{{v}_{i} ∈ V} max ( {c}_{i} - {d}_{i} , 0 ) \}$$

Suppose A₁* precedes all the remaining batches in S* and let A₂*=A−A₁* then we can decompose the above equation as:

$$\begin{matrix}f ( {S}^{*} ) = {min}_{{S}^{*} ∈ {P}_{1}} \{ ( {\sum }_{{v}_{i} ∈ {A}_{1}} max ( {c}_{i} - {d}_{i} , 0 ) ) + ( {\sum }_{{v}_{i} ∈ {S}^{*} - {A}_{1}} max ( {c}_{i} - {d}_{i} , 0 ) ) \} & ( 8 ) \\ f ( {S}^{*} ) = f ( {S}_{1}^{*} ) + f ( {S}_{2}^{*} ) & \end{matrix}$$

Where S*₁={A₁} and S₂*={B₁*, C₁*, D₁*, . . . Aₙ*, Bₙ*, Cₙ*, Dₙ*}

Using lemma 1 we can prove that S₂* must be the optimal batch sequence for the reduced set V₂={B*, C*, D*, A₂*}. The A₂ is placed at the end of the sets to establish next processing batch selection precedence. We can generalize this equation for the whole problem with boundary condition F(Φ)=0 as below:

$$F ( V ) = A , B , C , D ) = f ( {S}^{*} ) = {min}_{{S}^{*} ∈ {P}_{1}} \{ ( f ( {A}_{1} ) + F ( B , C , D , {A}_{2} ) \} \qquad ( 9 )$$

When A₁ precedes all the vehicles in schedule S*.

Furthermore, we have shown that the complexity of finding an optimal solution using the above approach is very high. To find a feasible solution that is near optimal, we assume that all the vehicles from direction B, C and D will be ready to process when we finish the processing of batch A₁. While calculating the batch size of A₁, we also assume that processing all the vehicles from B, C, and D before processing vehicles from batch A₂ yields a feasible solution. Let C₁ be the total processing time of the last vehicle from batch A₁. If all the vehicles from directions B, C, and D are ready to access the intersection, the wait time for every vehicle will be increased by C₁. If C₂ is the total processing time for all the vehicles from directions B, C and D, including setup time for all the directions, then wait time for the vehicles in A₂ will be increased by C₂. If n₁ is the size of A₁, n₂ is the size of A₂ and n_{bcd} is the size of {B, C, and D} combined. Then, below will be the total wait time for all the vehicles:

f(V)=0*n₁+C₁* [symbol] +C₂*n₂ (10)

The optimal value of the equation (10) will provide the near optimal batch size for A₁. The complexity of finding the optimal value for equation (10) is linear. Using the equation (9) and (10) we can iteratively find a feasible solution for this problem in the polynomial time complexity.

To improve the quality of the solution, we apply the following rules while calculating the batch size from each direction:
(a) The batch processing size must not exceed the waitₘₐₓ cap for that conflicting direction.
(b) The processing time for the other conflicting directions B, C, and D are capped using the waitₘₐₓ cap of the corresponding direction. Also the count of vehicles are capped using this parameter.
(c) The problem of self-synchronization of the vehicles at one intersection involves groups of non-conflicting directions that can access the intersection together while conflicting with other groups. This property adds another level of complexity to the equation. While selecting the batch size for one conflicting group, we need to account for all the non-conflicting directions in that group. Therefore, equation (9) is optimized for a group of directions in place of just one direction.
(d) A batch is selected from every conflicting group in a round robin sequence. The batch size can be 0 from any conflicting group based on the value of the optimization equation. To eliminate the recursive wait, we apply a rule that if at least one vehicle waiting from at least one non-conflicting direction in a processing group, then the batch size for that group can't be zero.

As discussed above, the self-synchronization problem is a real time problem. Vehicles join and leave the queue at the intersection arbitrarily. If we calculate a whole new solution for every changing scenario, it will not be feasible in the real world. The vehicles that are set to access the intersection in the next few seconds can't be stopped immediately, doing this may cause hazardous situations. Hence, while generating a new schedule, we must consider if there is a schedule exists for prior situation at the intersection. If a schedule exists, the vehicles that joined the intersection recently have two options a) to be allotted to an existing batch or b) form a new batch. The new vehicles can be allotted to an existing batch, if the batch was terminated due to unavailability of vehicles and have enough capacity to accommodate new vehicles such that adding them to the existing batch does not impact the overall value of optimization function or reduce it.

The vehicular environment is a very dynamic environment. It requires obtaining of a scheduling solution before the current problem scenario changes. Approaches like genetic algorithms, neighborhood searches, neural networks, and dynamic programming require processing through multiple possible scheduling sequences to find a feasible solution. In the vehicular environment, we do not have the luxury of time. The algorithm must be fast and should produce the feasible solution within a couple of seconds.

We can opt for advanced heuristics or environment specific expert systems to obtain a feasible schedule. The problem of providing a green channel to the maximum number of vehicles in the problem set has several unique properties such as machine constraint, transfer time, setup time, conflicting, and non-conflicting families of jobs, etc. Considering the uniqueness of the problem, we propose to apply the expert system approach.

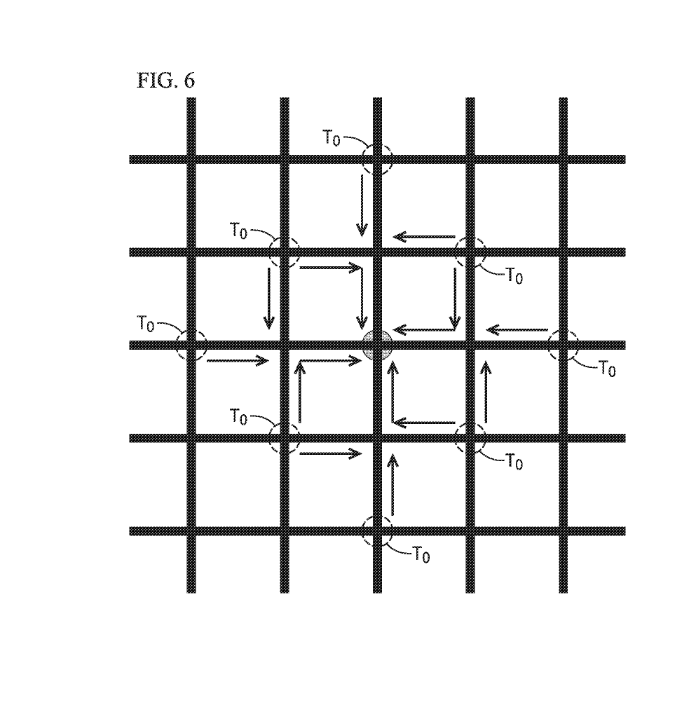

Setup for multiple intersection problem is shown in FIG. 3. Suppose a vehicle V has three consecutive intersections X, Y, and Z on its route. The vehicle is reaching intersection X at time T₀. It takes t₁ time to travel from intersection X to Y and t₂ from Y to Z. The goal of this problem is to make intersection X accessible for V at time T₀, intersection Y accessible at time T₀+t₁, and intersection Z at time T₀+t₁+t₂. FIG. 3 shows that there can be 12 freedom of movement at a 4-way intersection. At a 4-way intersection, every direction of movement conflicts with 6 other directions. FIG. 6 displays a scenario of vehicles conflict when synchronized for the three intersections ahead. All the vehicles that are reaching the intersection indicated with a circle at time T₀ can reach the intersection indicated with a center circle at the same time. So, if the vehicle at the circle intersection at time T₀ has the center circle intersection in its route, it must synchronize with the vehicles that are present at the other circled intersection at time T₀. Here we assume that the travel time between each intersection is the same. If the travel time between different intersections differs, a vehicle may conflict with a very different set of vehicles. Here our emphasis is on the fact that though at a given intersection, movement of a vehicle may conflict with 6 other directions of movement. If we plan to synchronize its movement three intersection ahead, the degree of conflicting directions of movement increases remarkably.

Finding the optimal schedule for this problem is very complex. Due to the precedence rule and machine restrictions a slight change in scheduling at one intersection may cause huge differences in scheduling for the other involved intersections. Therefore, to ease the complexity of the problem we propose the following assumptions:
(a) At every intersection there are 12 freedom of movements or conflicting directions. We assume that each batch from each direction is a job instead of every vehicle. Processing time of each batch depends on the number of vehicles included in the batch.
(b) We define four major conflicting groups and 4 non-major non-conflicting groups at an intersection similar to the groups defined in the one intersection problem. A 4-way intersection has two cross roads. In general, the directions of cross roads are north-south and east-west. Therefore, we group the conflicting groups moving in the same direction as soft-conflicting groups. So, at a 4-way intersection there would be two soft-conflicting groups. Each soft-conflicting group involves 2 major conflicting groups and 2 non-major conflicting groups.
(c) We define a processing cycle time for each intersection. Each major conflicting direction (or major conflicting group) accesses the intersection one by one in the round robin approach. When each of the directions or groups has been provided access, we call it a processing cycle. For example, there are conflicting groups A, B, C and D at an intersection I. A starts accessing the intersection at time T₀. Then, B starts at T₁. Then C starts at T₂ and D starts at T₃. When D finishes at time T₄, then time (T₄−T₀) is a cycle time for intersection I. Therefore, cycle time at an intersection defines the maximum wait time for a direction. The Waitₘₐₓ for an intersection defines the maximum cycle duration for it. Actual processing cycle time can be obtained by adding the processing time for the major conflicting groups. The processing time for the major conflicting groups is equal to the maximum batch processing time for the directions involved in it.
(d) We also define max duration a direction can access the intersection uninterrupted using waitₘₐₓ cap for the direction. Waitₘₐₓ cap of a soft-conflicting group can be obtained by adding the waitₘₐₓ cap for its major conflicting group. Waitₘₐₓ cap for a conflicting group equals the maximum value for the waitₘₐₓ cap for its major conflicting direction.

Properties of the solution for green channel problems are very similar to that of the self-synchronization of vehicles at one intersection. The differences are a) this problem involves more than one intersection and b) the optimization criteria is to maximize the number of vehicles with no wait. In our solution approach for green channel problems, we propose using different speed settings for every vehicle at every intersection. For instance, we can use the solution representation depicted above. With the addition of the speed setting, we also need a schedule at every intersection. Therefore, the solution for the green channel problem can be shown as below:

SG={SV_{I1},SV_{I2}, . . . SV_{In}}

Where SV_{Ix}={(V₁, s₁, p₁, d₁, w₁, sp₁), (V₂, s₂, p₂, d₂, w₂, spa)} represent schedule at intersection Iₓ. spᵢ is speed required by vehicle V, to arrive at the intersection on or before the start time (s₁).

FIG. 3 displays the setup of three intersections. If transfer time between each intersection is constant, and if the availability of the vehicles is consistent, then finding the solution for the green channel problem is very simple. We can simply set the cycle time for each intersection as twice the transfer time and batch size for each major conflicting group to half of the transfer time. Then, we can achieve non-stop movement for all the vehicles. For example, if there are 4 major conflicting groups A, B, C and D at each intersection, and transfer time between the intersections is 30 seconds, then we set the cycle time as 60 seconds and the batch time for A, B, C and D to be 15 seconds. With reference to FIG. 3 Error! Reference source not found, if T₁=0 then T₂=30, T₃=60. Delta will be 30 seconds (since there are two major conflicting groups on each cross road.) At Intersection 122 vehicles from left to right will reach the intersection at 30 second mark and finish at 60 second mark. Similarly, vehicles from top to bottom will arrive the intersection at 60 second mark and will finish at 90 second mark. This way no vehicle has to stop at any intersection.

The scenario presented above is an ideal scenario and it is not always the case in the real world. The transfer times between intersections are arbitrary and the availability of vehicles is also not consistent. Though we can't control the availability of vehicles, the transfer time taken by each vehicle can be controlled by manipulating the travelling speed of the vehicles.

If we know the cycle time for intersections and can calculate a time slot for each of the conflicting groups, we can adjust the release time for a vehicle such that it reaches the intersection when the intersection is available for it. Suppose b1 and b2 are two successive batches from direction A. Batch b1 starts at T₀ and its processing time is P₀. If the cycle time for the intersection is CT then the batch b2 will start at T₀+CT. If a vehicle reaches an intersection between T₀+P₀ and T₀+CT, it will have to stop at the intersection. We call it idle time interval for a direction and it can be calculated as (CT−P₀). A vehicle has to make decisions if it can reach the intersection before T₀+P₀ by speeding up or if it can slow down and reach the intersection at T₀+CT.

The time vehicles can make-up or lose using speed manipulation depends on the distance between the two intersections. The worst-case scenario for a vehicle is when with normal speed limits it is arriving at the intersection exactly at the middle of idle time. If the idle time interval for a direction is large, it will be difficult for a vehicle to gain or lose the sufficient time using speed manipulations, but if the idle time is small then it is easily possible. The time a vehicle can gain or lose can be calculated using maximum/minimum speed limit and distance between two intersections. If there are two intersections I and J, AvgS_{IJ} is the average speed limit, MaxS_{IJ} is the maximum speed limit and MinS_{IJ} is the minimum speed limit between the intersections I and J. TR_{IJ} is the transfer time defined. Then, we define gain time G_{IJ} and lose time L_{IJ} for the intersection I, J as:

G_{II}=|(TR_{II}(AvgS_{II}/MaxS_{II})−TR_{II}|

L_{II}=|TR_{II}−(TR_{II}*AvgS_{II}/MinS_{II})|

The cycle time depends on the number of vehicles traveling from each direction. Since we cap the maximum batch processing time using Waitₘₐₓ cap for each direction, we limit the idle time for each conflicting direction.

It is very difficult to find an algorithm to get the optimal solution for the green channel problem. We propose the following scheduling algorithm that will ensure non-stop movement for vehicles moving straight, but it can't ensure non-stop movement of vehicles turning left or right.
(1) Select a grid of adjacent intersections to be synchronized. The grid dimension must be at least 3×3.
(2) Find the min (Gᵢⱼ+Lᵢⱼ) for the grid.
(3) Set the Waitₘₐₓ for each intersection in grid as (min (Gᵢⱼ,+Lᵢ)).
(4) Set Waitₘₐₓ cap for major directions as Waitₘₐₓ/2.
(5) Set Waitₘₐₓ cap for minor directions as Waitₘₐₓ/4.
(6) For each vehicle V at the intersection I, do the following:
(6a) Find the size and finish time of the last batch from direction, from which vehicle V is moving.
(6b) Find the idle time for the intended direction based on the current cycle processing time.
(6c) If adding V to the last batch causes it to violate waitₘₐₓ cap for the direction or if V will not be able to arrive at the intersection before the finish time of the last batch, then create a new batch starting with vehicle V, and update its release time and required speed.
(6d) If adding V to the last batch doesn't violate the waitₘₐₓ cap for the direction and if V can reach the intersection at the finish time of the last batch, then add V to the last batch. Update the release time and speed for V. Update the start time and speed for all the vehicles impacted by this insert.

Since we are scheduling vehicles at least three intersections ahead, the cycle times and idle time for each direction and for each batch will be known well in advance. Hence, a sudden change in schedule is highly unlikely. If the arrival rate of vehicles at an intersection from a particular direction is extraordinarily high and other directions at the same intersection are not crowded, then it will require the vehicles from that direction to slow down or wait at the entry point of the problem grid.

This invention can be further illustrated by the following examples of embodiments thereof, although it will be understood that these examples are included merely for the purposes of illustration and are not intended to limit the scope of the invention unless otherwise specifically indicated.

### EXAMPLES

We developed a computer-based simulation program that provided a graphical representation for a solution developed for self-synchronization of the one intersection problem. The simulation program was divided into four modules: a) contextual information generator, b) message transmitter, c) schedule generator, and d) graphics generator. The first three modules were combined into an executable module. One instance of this module was executed for every vehicle in test environment. Only one instance of graphics generator module was executed. These modules were developed using Visual Studio 2012. It was executed on a machine that has Intel 15 processors, 4 GB of RAM, and Windows 10 OS.

The contextual information generator module was responsible for generating the initial data for a vehicle. This module also recalculated the contextual information for corresponding vehicle after a small stipulated time period.

The message transmitter module was a simulation of communication protocol which broadcasts the contextual information of one vehicle to all the other instances of simulator. Along with contextual information this module is responsible for transmission of calculated schedule.

The schedule generator module was core of this simulation. It gathered contextual information from every vehicle. Using this information, it generates a schedule and pass it to transmission module for broadcast.

The graphics generator module collected contextual information for all the vehicles and plotted them on the screen based on current longitude and latitude of the vehicle. The graphics refreshed very frequently to smooth out the animation of vehicle movements.

To analyze the scheduling algorithm, we performed numerous tests with various sample data. We used a random number generator to determine processing time and release time for every vehicle so that we could obtain arbitrary values for it. The random value range for processing time was from 1 to 6. Random time interval between release-time of two consecutive vehicles ranged from 1 to 10. Our purpose of generating sample data was to mimic various scenarios of vehicle formation at an intersection. Following are the scenarios for which we generated sample data and have performed scheduling on it.

The following data was based on evenly distributed vehicles across all directions (10 Samples each for 5, 10, 20 and 50 vehicles in each direction). This included assuming low numbers of vehicles in directions turning left or right and high number of vehicles going straight. This was based on 10 samples each for minimum of 5, 10 vehicles going straight. This sample data also considered a random distribution vehicles (10 samples).

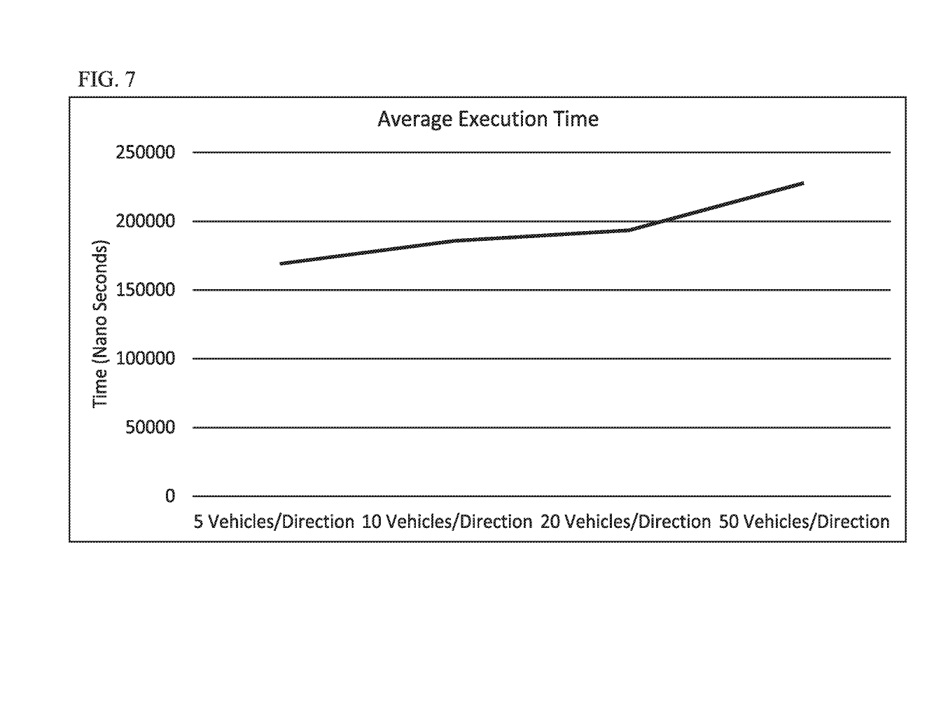

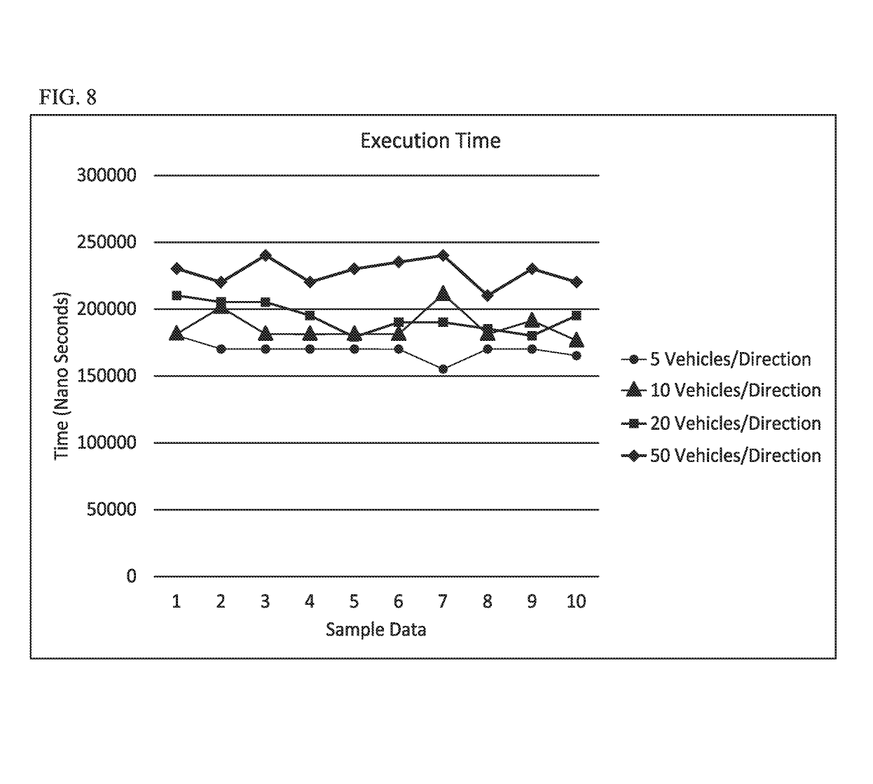

FIGS. 7 and 8 depict chart showing the execution time taken by the scheduling algorithm. Analysis of this data shows that execution time for the algorithm increased in linear order with an increase in number of vehicles per direction. Moreover, the maximum execution time for this algorithm for 50 vehicles per direction, total 600 vehicles, was less than 0.3 seconds. This fulfill the requirement of real time execution condition. TABLE 8, below, lists the data serving as the basis for FIGS. 7 and 8.

TABLE 8
Execution Time

| Number Of vehicles | 1 | 2 | 3 | 4 | 5 | 6 | 7 | 8 | 9 | 10 |
|---|---|---|---|---|---|---|---|---|---|---|
| 5 Vehicles/Direction | 180332 | 170111 | 170009 | 170105 | 170140 | 170135 | 155103 | 170111 | 170129 | 165184 |
| 10 Vehicles/Direction | 180126 | 200128 | 180127 | 180120 | 180126 | 180097 | 210131 | 180103 | 190136 | 175218 |
| 20 Vehicles/Direction | 210198 | 205211 | 205181 | 195213 | 179022 | 190100 | 190124 | 185192 | 180114 | 195068 |
| 50 Vehicles/Direction | 230151 | 220117 | 240155 | 220171 | 230151 | 235204 | 240239 | 210131 | 230145 | 220238 |

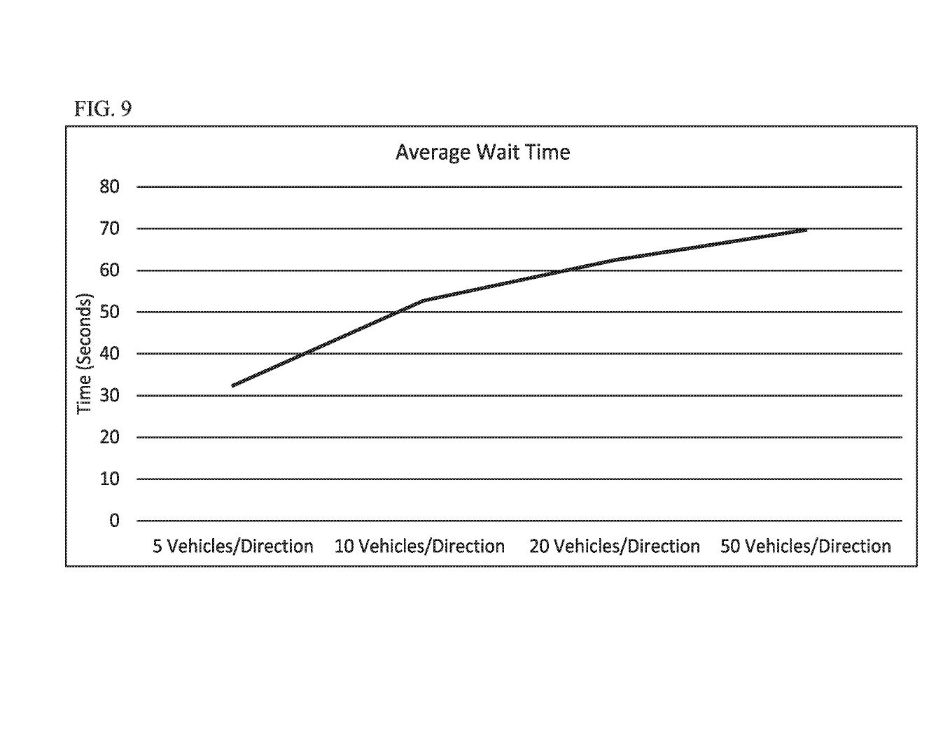

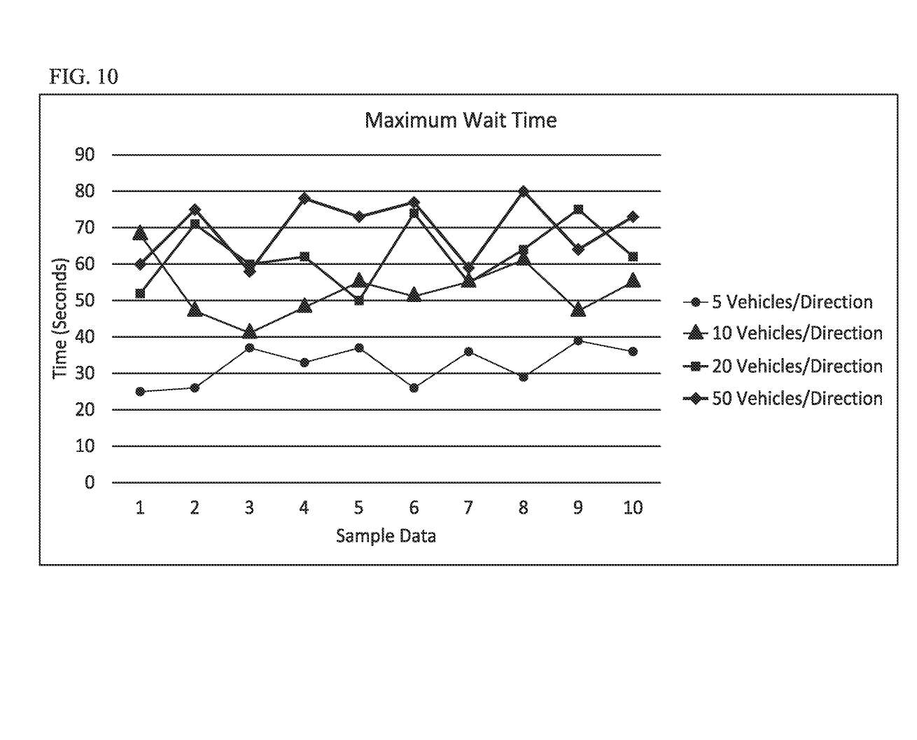

FIGS. 9 and 10 depict charts showing the maximum wait time for even distribution of vehicles at an intersection. Analysis of this data shows that value for waitₘₐₓ doesn't correlate with the number of vehicles directly. Because the waitₘₐₓ cap is enforced, the maximum wait time value remains below or very close to this limit. The value of maximum wait time depends on distribution of vehicles and their release time. TABLE 9, below, lists the data serving as the basis for FIGS. 9 and 10.

TABLE 9
Maximum Wait Time

| Number Of vehicles | 1 | 2 | 3 | 4 | 5 | 6 | 7 | 8 | 9 | 10 |
|---|---|---|---|---|---|---|---|---|---|---|
| 5 Vehicles/Direction | 25 | 26 | 37 | 33 | 37 | 25 | 36 | 29 | 39 | 36 |
| 10 Vehicles/Direction | 68 | 47 | 41 | 48 | 55 | 51 | 55 | 61 | 47 | 55 |
| 20 Vehicles/Direction | 52 | 71 | 60 | 62 | 50 | 74 | 55 | 64 | 75 | 62 |
| 50 Vehicles/Direction | 60 | 75 | 58 | 78 | 73 | 77 | 59 | 80 | 64 | 73 |

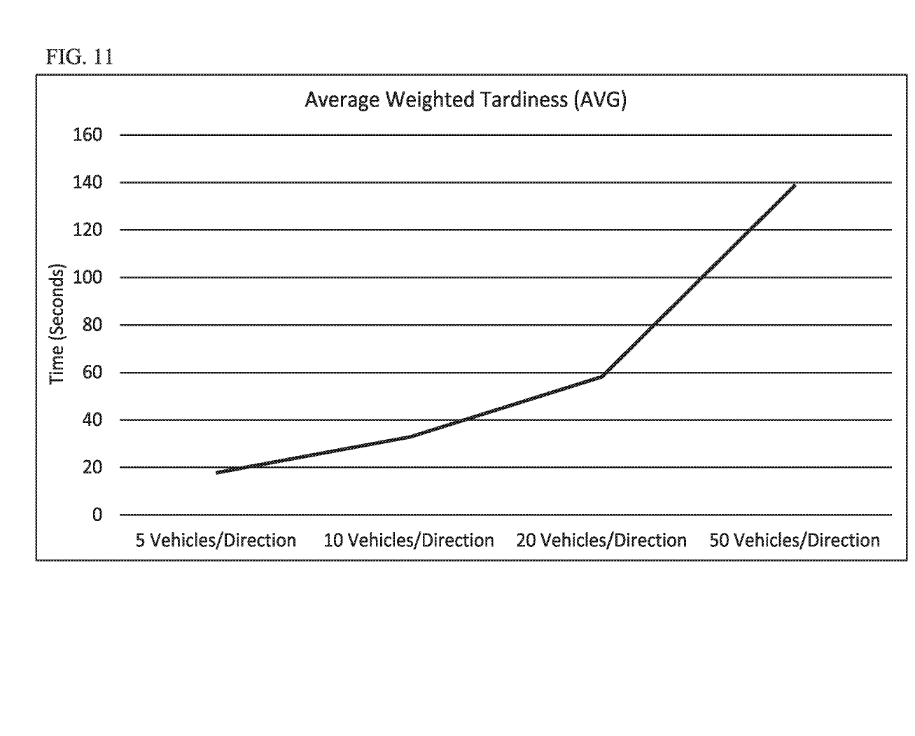

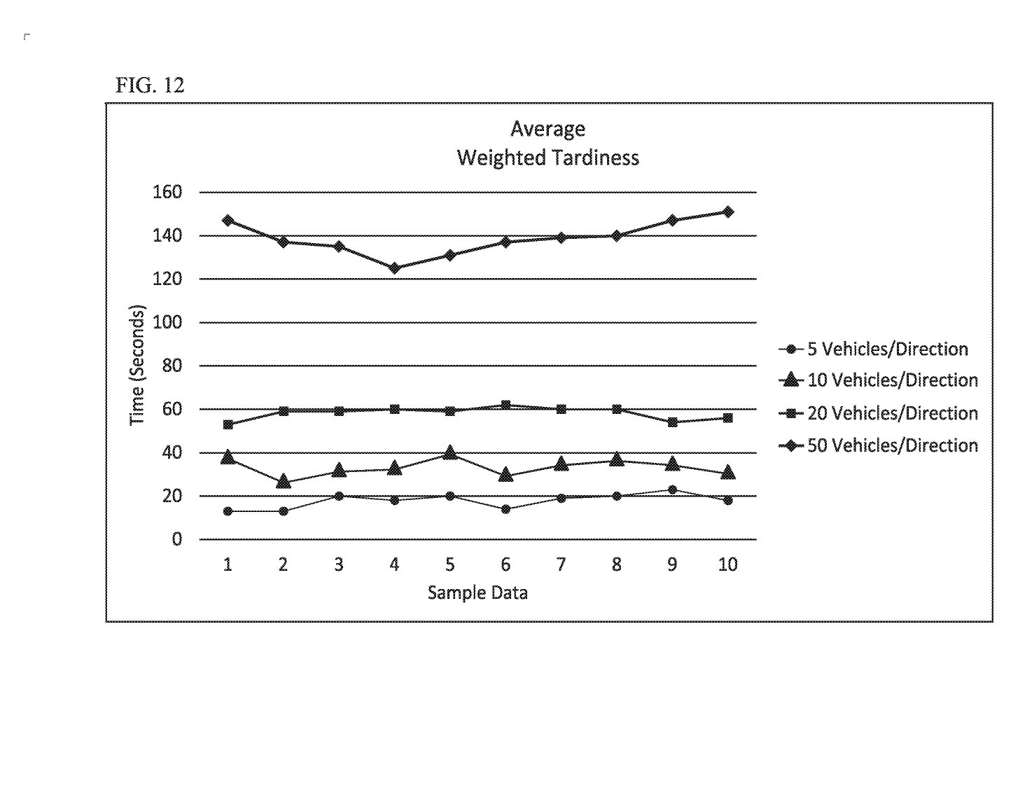

FIGS. 11 and 12 depict charts showing the average weighted tardiness for evenly distributed vehicles at the intersection. This data shows that the average weighted tardiness can have higher values if the number of vehicles increases at the intersection. The average waited tardiness remained in close range for different samples of same series. Hence, we can conclude that, using this algorithm, we can estimate the average tardiness if we know number of vehicles at the intersection. TABLE 10, below, lists the data serving as the basis for FIGS. 11 and 12.

TABLE 10
Average Weighted Tardiness

| Number Of vehicles | 1 | 2 | 3 | 4 | 5 | 6 | 7 | 8 | 9 | 10 |
|---|---|---|---|---|---|---|---|---|---|---|
| 5 Vehicles/Direction | 13 | 13 | 20 | 18 | 20 | 14 | 19 | 20 | 23 | 18 |
| 10 Vehicles/Direction | 37 | 26 | 31 | 32 | 39 | 29 | 34 | 36 | 34 | 30 |
| 20 Vehicles/Direction | 53 | 59 | 59 | 60 | 59 | 62 | 60 | 60 | 54 | 56 |
| 50 Vehicles/Direction | 147 | 137 | 135 | 125 | 131 | 137 | 139 | 140 | 147 | 151 |

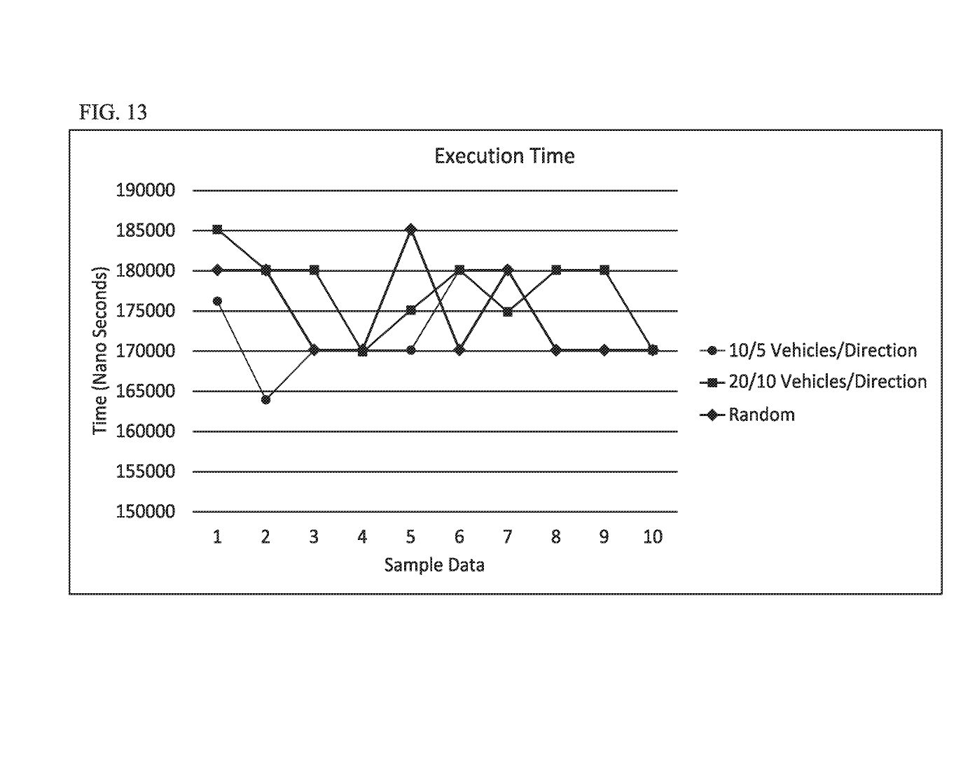

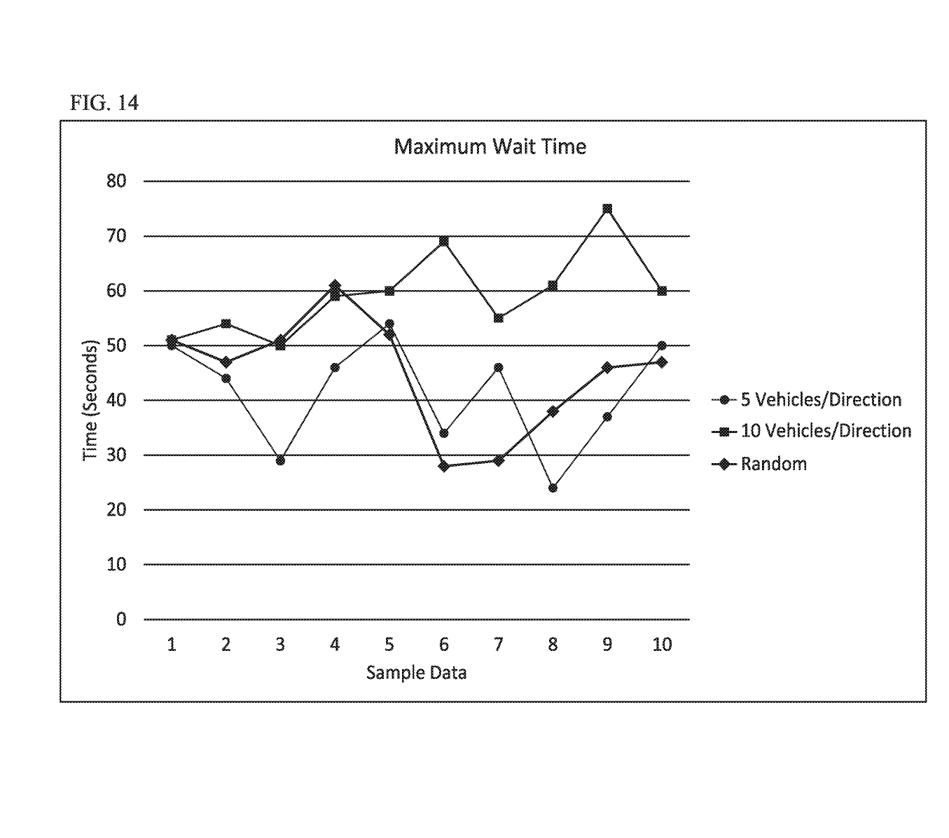

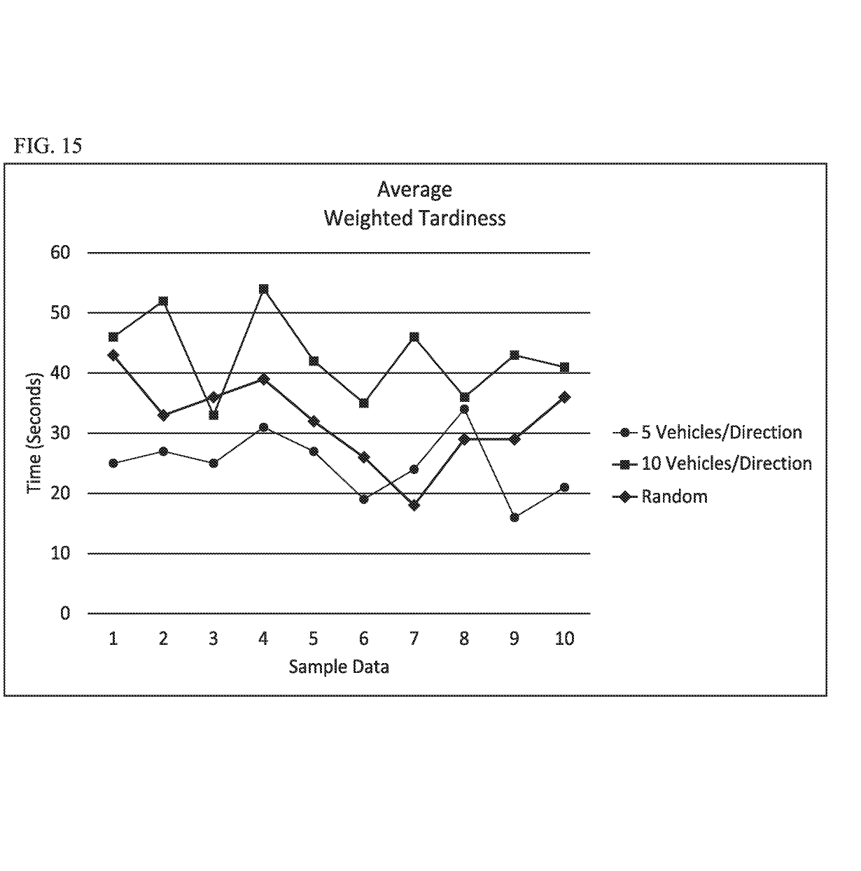

FIGS. 13-15 depict charts providing statistics for execution time, maximum wait time, and average tardiness for uneven distribution of vehicles as well as random distribution of vehicles. Analysis of these chart shows that the values for optimization variables follows the same pattern displayed above.

### Definitions

It should be understood that the following is not intended to be an exclusive list of defined terms. Other definitions may be provided in the foregoing description, such as, for example, when accompanying the use of a defined term in context.

As used herein, the terms “contextual information” and “contextual data” may be used interchangeably and may comprise any information about the associated vehicle, such as the geographical location of the vehicle (e.g., spatial information from the GPS component), the identification information of the vehicle, the speed of the vehicle, the direction of travel, the desired destination of the vehicle, and/or the driving prediction of the vehicle.

As used herein, an “intersection” refers to a place within a synchronization space wherein two or more roads cross each other.

As used herein, a “non-intersection” refers to a place which is neither an intersection nor within the range of communication of an intersection that resides in the same cell.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are illustrative only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above described memory types are examples only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “memory,” “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### NUMERICAL RANGES

The present description uses numerical ranges to quantify certain parameters relating to the invention. It should be understood that when numerical ranges are provided, such ranges are to be construed as providing literal support for claim limitations that only recite the lower value of the range as well as claim limitations that only recite the upper value of the range. For example, a disclosed numerical range of 10 to 100 provides literal support for a claim reciting “greater than 10” (with no upper bounds) and a claim reciting “less than 100” (with no lower bounds).

### CLAIMS NOT LIMITED TO DISCLOSED EMBODIMENTS

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A self-synchronization device for vehicles, the self-synchronization device comprising:
(a) a GPS component for receiving location information;
(b) a first radio for providing a control channel inside a designated synchronization cell;
(c) a second radio for a service channel inside the designated synchronization cell; and
(d) a third radio for a long-range communication channel between a plurality of designated synchronization cells.

2. The self-synchronization device of claim 1, further comprising an audio/visual unit for displaying instructions to a user of a vehicle.

3. The self-synchronization device of claim 1, wherein the self-synchronization device is configured to communicate between a plurality of vehicles in the designated synchronization cell via the second radio.

4. The self-synchronization device of claim 3, wherein the self-synchronization device is configured to synchronize traffic conditions between the plurality of vehicles so that each vehicle may move through an intersection without a traffic signal or any other external traffic regulating agent, and
wherein the self-synchronization device is configured to ensure safe passage for the plurality of vehicles through the intersection without causing any collision and thereby minimize an amortize wait time for the plurality of vehicles at the intersection.

5. The self-synchronization device of claim 1, wherein said self-synchronization device is placed within a vehicle, and wherein the device is configured to submit contextual data of the vehicle to other vehicles within the designated synchronization cell space.

6. The self-synchronization device of claim 1, wherein the first radio, the second radio, and the third radio comprise DSRC radios.

7. A computer-implemented method for self-synchronization of vehicles, the method comprising the steps of:
(a) obtaining contextual data from a GPS component of a self-synchronization device positioned in a vehicle when the vehicle enters a synchronization space;
(b) establishing a cell master vehicle in the synchronization space;
(c) registering the vehicle with the cell master vehicle via a first radio of the self-synchronization device if the vehicle is not established as the cell master vehicle;
(d) communicating the contextual data to other vehicles present within the synchronization space via a second radio of the self-synchronization device;
(e) receiving comparative contextual data from the other vehicles present within the synchronization space via the second radio;
(f) transmitting the contextual data and the comparative contextual data to other synchronization spaces via a third radio in the self-synchronization device if the vehicle is established as the cell master vehicle;
(g) formulating a traffic schedule based on the contextual data and comparative contextual data; and
(h) providing driving instructions to the vehicle based on the traffic schedule.

8. The computer-implemented method of claim 7, wherein the first radio, the second radio, and the third radio operate using DSRC channels.

9. The computer-implemented method of claim 8, wherein the first radio operates on DSRC channel 182, the second radio operates on DSRC channels 174, 176, 178, or 180, and the third radio operates on DSRC channel 184.

10. The computer-implemented method of claim 7, wherein the comparative contextual data from the other vehicles is accumulated by additional self-synchronization units within the other vehicles.

11. The computer-implemented method of claim 7, wherein the providing of step (h) comprises displaying the driving instructions to a user of the vehicle when the vehicle comprises a non-autonomous vehicle.

12. The computer-implemented method of claim 7, wherein formulating of step (g) comprises calculating a schedule for each vehicle in the synchronization space so as to mitigate wait times for each vehicle and maximize traffic flow through intersections.

13. The computer-implemented method of claim 7, wherein the computer-implemented method may be carried out in the absence of a traffic signal or any other external traffic regulating agent.

14. The computer-implemented method of claim 7, wherein the cell master vehicle registers the initial vehicle and the other vehicles in the synchronization space and assigns virtual identifications to the vehicle and the other vehicles in the synchronization space, wherein the cell master vehicle maintains a catalogue of vehicles present in the synchronization space in the form of registration data.

15. The computer-implemented method of claim 14, wherein the cell master vehicle transmits the registration data to the vehicle and the other vehicles in the synchronization space using a self-synchronization device in the cell master vehicle.

16. The computer-implemented method of claim 7, wherein the contextual data comprises the identification information of the vehicle, the speed of the vehicle, the direction of travel, the desired destination of the vehicle, and/or the driving prediction of the vehicle.

17. A self-synchronization system for vehicles, the self-synchronization system comprising:
(a) a memory device for storing data; and
(b) a processor communicatively coupled to the memory device, wherein the processor may be programmed to:
(i) obtain contextual data from a GPS component in a self-synchronization device of a vehicle when the vehicle enters a synchronization space;
(ii) establish a cell master vehicle in the synchronization space;
(iii) register the vehicle with the cell master vehicle via a first radio of the self-synchronization device if the vehicle is not established as the cell master vehicle;
(iv) communicate the contextual data to other vehicles present within the synchronization space via a second radio of the self-synchronization device;
(v) receive comparative contextual data from the other vehicles present within the synchronization space via the second radio of the self-synchronization device;
(vi) transmit the contextual data and the comparative contextual data to other synchronization spaces via a third radio in the self-synchronization device if the vehicle is established as the cell master vehicle;
(vii) formulate a traffic schedule based on the contextual data and the comparative contextual data if the vehicle is established as the cell master vehicle; and
(viii) provide driving instructions to the vehicle in the synchronization space based on the traffic schedule.

18. The self-synchronization system of claim 17, wherein the first radio, the second radio, and the third radio operate using a DSRC protocol.

19. The self-synchronization system of claim 17, wherein the comparative contextual data is formulated by other self-synchronization devices in the other vehicles present within the synchronization space.

20. The self-synchronization unit of claim 17, wherein the processor is further programmed to provide the driving instructions to a user via an audio and/or visual interface.
